(19) United States
(12) Patent Application Publication
(10) Pub. No.: US 2017/0265240 A1
(43) Pub. Date: Sep. 14, 2017

(54) SYSTEMS AND METHODS FOR DEVICE COMMUNICATION USING ADAPTIVE TONE PLANS

(71) Applicant: QUALCOMM Incorporated, San Diego, CA (US)

(72) Inventors: Jialing Li Chen, San Diego, CA (US); Lin Yang, San Diego, CA (US); Sameer Vermani, San Diego, CA (US); Bin Tian, San Diego, CA (US)

(21) Appl. No.: 15/454,749

(22) Filed: Mar. 9, 2017

Related U.S. Application Data
(60) Provisional application No. 62/307,386, filed on Mar. 11, 2016.

(51) Int. Cl. H04W 76/02; H04W 72/04

(52) U.S. Cl. CPC H04W 76/025; H04W 72/0446

(57) ABSTRACT

Methods and apparatuses for wireless communication according to various tone plans are provided. In one aspect, a method includes determining a first device communicates data within a 40 MHz, 80 MHz, or 160 MHz first frequency range and a second device communicates data within a 20 MHz second frequency range of the first frequency range, selecting first communication parameters for the first device and second communication parameters for the second device based on the determination; and communicating first data with the first device according to the first communication parameters at least partially simultaneously with communicating second data with the second device according to the second communication parameters.

### CROSS REFERENCE TO RELATED APPLICATIONS

This application claims priority to U.S. Provisional Application 62/307,386, filed Mar. 11, 2016 and entitled “SYSTEMS AND METHODS FOR DEVICE COMMUNICATION USING ADAPTIVE TONE PLANS.” The disclosure of this prior application is consider part of this application, and is hereby incorporated by reference in its entirety.

### FIELD

Certain aspects of the present disclosure generally relate to wireless communications, and more particularly, to methods and apparatuses for multiplexing transmissions to devices having different frequency ranges within which they can receive data.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices share a communication network, congestion and inefficient link usage can result. As such, systems, methods, and non-transitory computer-readable media are needed for improving communication efficiency in high efficiency wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect disclosed is an apparatus for communicating with multiple devices. The apparatus includes an electronic hardware processor, configured to: determine a first device communicates data within a 40 Mhz, 80 Mhz, 160 Mhz or 80-plus-80 Mhz first bandwidth and a second device communicates data within a 20 Mhz second bandwidth, wherein the second bandwidth is within the first bandwidth, select a first tone plan for the first device and a second tone plan for the second device based on the determination, and communicating first data with the first device according to the first tone plan at least partially simultaneously with communicating second data with the second device according to the second tone plan.

In some aspects, the first and second tone plans restrict a center 26 tone resource unit within the 20 Mhz second bandwidth. In some aspects, the electronic hardware processor is configured to determine that the first device communicates within the 40 Mhz first bandwidth, and the second tone plans restrict a 5^{th} and a 14^{th} 26 tone resource unit of the 20 Mhz second bandwidth. In some aspects, the electronic hardware processor is configured to determine that the first device communicates within the 80 Mhz first bandwidth, and the second tone plans restrict the 5^{th}, 10^{th}, 14^{th}, 19^{th}, 24^{th}, 28^{th}, and 33^{rd} 26 tone resource units within the 20 Mhz second bandwidth, or determine that the first device communicates within the 160 Mhz or 80+80 Mhz first bandwidth, and the second tone plan restricts the 5^{th}, 10^{th}, 14^{th}, 19^{th}, 24^{th}, 28^{th}, and 33^{rd} 26 tone resource units in the 20 Mhz second bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth.

In some aspects, the electronic hardware processor is configured to determine that the first device communicates within the 80 Mhz first bandwidth, and the second tone plan restricts the 5th and 12th 52 tone resource units in the 20 Mhz second bandwidth, or the first device communicates within the 160 Mhz or 80-plus-80 Mhz first bandwidth, and the second tone plan restricts the 5^{th} and 12^{th} 52 tone resource units in the 20 Mhz second bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth.

In some aspects, the electronic hardware processor is configured to determine that the first device communicates within the 80 Mhz first bandwidth, and the second tone plan restricts the 3^{rd} and 6^{th} 106 tone resource within the 20 Mhz second bandwidth, or determine that the first device communicates within the 160 Mhz or 80+80 Mhz first bandwidth, and the second tone plan restricts the 3^{rd} and 6^{th} 106 tone resource units in the 20 Mhz second bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth. In some aspects, the first tone plan utilizes a set of tones within the second bandwidth to communicate data, and the second tone plan utilizes a subset of the set of tones within the second bandwidth to communicate data. In some aspects, the electronic hardware processor is further configured to determine a third device communicates data within the 40 MHz, 80 MHz, 160 MHz, or 80 Mhz+80 Mhz first bandwidth and a fourth device communicates data within the 20 MHz second bandwidth, wherein the second bandwidth is within the first bandwidth, select the first tone plan for the third device and the second tone plan for the fourth device based on the determination; and communicate third data with the third device according to the first tone plan at least partially simultaneously with communicating fourth data with the fourth device according to the second tone plan. In some aspects, the electronic hardware processor is further configured to communicate the third and fourth data at least partially simultaneously with the communication of the first and second data. In some aspects, the electronic hardware processor is configured to determine that the first device transmits data within the first bandwidth, and the second tone plan restricts the 242 tone resource unit. In some aspects, the electronic hardware processor is configured to determine that the first device receives data within the first bandwidth, and the second tone plan restricts the 242 tone resource unit. In some aspects, the electronic hardware processor is configured to determine that the first device receives data within the first bandwidth, and the second tone plan does not restrict the 242 tone resource unit.

Another aspect disclosed is a method of communicating data with multiple devices. The method includes determining, by an electronic device, a first device communicates data within a 40 MHz, 80 MHz, 160 MHz or 80-plus-80 Mhz first bandwidth and a second device communicates data within a 20 MHz second bandwidth, wherein the second bandwidth is within the first bandwidth, selecting, by the electronic device, a first tone plan for the first device and a second tone plan for the second device based on the determination; and communicating, by the electronic device, first data with the first device according to the first tone plan at least partially simultaneously with communicating second data with the second device according to the second tone plan.

Another aspect disclosed is an apparatus for receiving data. The apparatus includes a receiver, configured to receive a multi-user communication from a first device, wherein the multi-user communication includes first data for a second device encoded according to a first tone plan over a first bandwidth and second data for a third device encoded according to a second tone plan over a 20 Mhz second bandwidth included in the first bandwidth; and a hardware processor configured to decode the multi-user communication according to the first or second tone plans.

In some aspects, the hardware processor is further configured to decode the multi-user communication while excluding a center 26 tone resource unit in the 20 Mhz second bandwidth according to the first or second tone plan. In some aspects, the first data is encoded over a 40 Mhz bandwidth, and wherein the hardware processor is further configured to decode the multi-user communication while excluding a 5th and a 14th 26 tone resource unit of the 20 Mhz second bandwidth according to the second tone plan. In some aspects, the first data is encoded over an 80 Mhz first bandwidth and the hardware processor is further configured to decode the multi-user communication while excluding the 5^{th}, 10^{th}, 14^{th}, 19^{th}, 24^{th}, 28^{th}, and 33^{rd} 26 tone resource units within the 20 Mhz bandwidth according to the second tone plan or the first data is encoded over the 160 Mhz or 80+80 Mhz first bandwidth, and the second tone plan restricts the 5th, 10th, 14th, 19th, 24th, 28th, and 33rd 26 tone resource units in the 20 Mhz second bandwidth according to the second tone plan, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth.

In some aspects, the first data is encoded over an 80 Mhz first bandwidth, and the hardware processor is further configured to decode the multi-user communication while excluding the 5th and 12th 52 tone resource units of the 20 Mhz second bandwidth according to the second tone plan, or the first data is encoded over a 160 Mhz or a 60+80 Mhz first bandwidth, and the hardware processor is further configured to decode the multi-user communication while excluding the 5^{th} and 12^{th} 52 tone resource units within the 20 Mhz second bandwidth according to the second tone plan, and wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth. In some aspects, the hardware processor is further configured to decode the multi-user communication while excluding the 3^{rd} and 6^{th} 106 tone resource units within the 20 Mhz second bandwidth according to the second tone plan, or the first data is encoded over a 160 Mhz or an 80+80 Mhz first bandwidth, and the hardware processor is further configured to decode the multi-user communication while excluding the 3rd and 6th 106 tone resource units in the 20 Mhz second bandwidth according to the second tone plan, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth.

In some aspects, the hardware processor is further configured to decode the multi-user communication while excluding the 242 tone resource unit within the 20 Mhz second bandwidth according to the second tone plan. In some aspects, the hardware processor is further configured to decode the multi-user communication by decoding the 242 tone resource unit within the 20 Mhz second bandwidth according to the second tone plan.

Another aspect disclosed is an apparatus for transmitting data. The apparatus includes a hardware processor configured to generate a portion of a multi-user communication, wherein the multi-user communication includes first data encoded according to a first tone plan over a first bandwidth and second data encoded according to a second tone plan over a 20 Mhz second bandwidth included in the first bandwidth; and a transmitter configured to transmit the portion of the multi-user communication according to the first or second tone plans. In some aspects, the hardware processor is further configured to restrict a center 26 tone resource unit in the 20 Mhz second bandwidth according to either the first or second tone plans when generating the portion.

In some aspects, the hardware processor is further configured to restrict a 5^{th} and a 14^{th} 26 tone resource unit of the 20 Mhz second bandwidth when encoding second data according to the second tone plan when generating the portion if first data is encoded over a 40 Mhz first bandwidth, and to restrict the 5th, 10^{th}, 14^{th}, 19^{th}, 24^{th}, 28^{th}, and 33rd 26 tone resource units of the 20 Mhz second bandwidth according to the second tone plan when generating the portion if first data is encoded over an 80 Mhz first bandwidth, and to restrict the 5^{th}, 10^{th}, 14^{th}, 19^{th}, 24^{th}, 28^{th}, and 33rd 26 tone resource units of the 20 Mhz second bandwidth according to the second tone plan when generating the portion if first data is encoded over a 160 Mhz or an 80+80 Mhz first bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth. In some aspects, the hardware processor is further configured to restrict a 5th and 12th 52 tone resource units of the 20 Mhz second bandwidth when encoding second data according to the second tone plan when generating the portion if the first data is encoded over a 80 Mhz first bandwidth, and the hardware processor is further configured to restrict the 5^{th} and 12^{th} 52 tone resource units of the 20 Mhz second bandwidth when encoding second data according to the second tone plan when generating the portion if the first data is encoded over a 160 Mhz or an 80+80 Mhz first bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth. In some aspects, the hardware processor is further configured to restrict a 3^{rd} and 6^{th} 106 tone resource units when encoding second data according to the second tone plan when generating the portion if first data is encoded over an 80 Mhz first bandwidth, and is further configured to restrict the 3^{rd} and 6^{th} 106 tone resource units when encoding second data according to the second tone plan when first data is encoded over a 160 Mhz or an 80+80 Mhz first bandwidth, wherein the 20 Mhz second bandwidth is within either a lower 80 Mhz of the 160 Mhz or 80+80 Mhz first bandwidth or an upper 80 Mhz of the 160 Mhz or 80+80 Mhz first bandwidth. In some aspects, the hardware processor is further configured to restrict a 242 tone resource unit when encoding second data according to the second tone plan when generating the portion.

Another aspect disclosed is an apparatus for communicating data with multiple devices. The apparatus includes means for determining a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width, means for selecting a first tone plan for communication by the first device based on the determination, wherein the first tone plan includes tones in one or more resource units in the first channel width, means for selecting a second tone plan for communication by the second device based on the determination, wherein the second tone plan includes tones in one or more resource units in the second channel width, and means for communicating first data with the first device according to the first tone plan at least partially simultaneously with communicating second data with the second device according to the second tone plan.

Another aspect disclosed is a computer readable storage medium comprising instructions that when executed cause a hardware processor to perform a method of communicating data with multiple devices. The method includes determining a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width, selecting a first tone plan for communication by the first device based on the determination, wherein the first tone plan includes tones in one or more resource units in the first channel width, selecting a second tone plan for communication by the second device based on the determination, wherein the second tone plan includes tones in one or more resource units in the second channel width, and communicating first data with the first device according to the first tone plan at least partially simultaneously with communicating second data with the second device according to the second tone plan.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 shows an exemplary 2N-tone plan, according to one embodiment.

FIG. 4 shows a system that is operable to generate interleaving parameters for orthogonal frequency-division multiple access (OFDMA) tone plans, according to an embodiment.

FIG. 5 shows an exemplary multiple-input-multiple-output (MIMO) system that can be implemented in wireless devices, such as a wireless device of FIG. 4, to transmit and receive wireless communications.

FIG. 6 shows use of tone plans to support communication with both reduced bandwidth devices and normal bandwidth devices in an operative embodiment.

FIG. 7 shows use of tone plans to support communication with both reduced bandwidth devices and normal bandwidth devices in an operative embodiment.

FIG. 8 shows use of tone plans to support communication with both reduced bandwidth devices and normal bandwidth devices in an operative embodiment.

FIG. 9 shows use of tone plans to support communication with both reduced bandwidth devices and normal bandwidth devices in an operative embodiment.

FIG. 10 shows use of tone plans to support communication with both reduced bandwidth devices and normal bandwidth devices in an operative embodiment.

FIG. 11 is a flowchart for a method of encoding data for devices based on a receive frequency range of each of the devices.

FIG. 12 is a flowchart for a method of decoding data encoded by the method of FIG. 13A

FIG. 13 is a flowchart for a method of decoding data encoded by the method of FIG. 13A

FIG. 14 is a flowchart for a method of encoding data for devices based on a receive frequency range of each of the devices.

FIG. 15 is a flowchart for a method of decoding data encoded by the method of FIG. 14.

FIG. 16 is a table of null subcarrier indices for high efficiency 20 MHz, 40 MHz, and 80 MHz tone plans in 802.11ax.

FIG. 17 is a table of subcarrier indices for resource units (RUs) in a 20 MHz high efficiency physical layer data unit (PPDU).

FIG. 18 is a table of subcarrier indices for resource units in a 40 MHz high efficiency PPDU.

FIG. 19 is a table of subcarrier indices for resource units in a 80 MHz high efficiency PPDU.

FIG. 20 is a flowchart of a method of selecting a tone plan.

FIG. 21 is a flowchart of a method of selecting an operating bandwidth.

FIG. 22 is a flowchart of a method of simultaneously communicating with multiple devices over different bandwidths.

FIG. 23 is a flowchart of a method of receiving a portion of a multi-user communication.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A wireless local area network (WLAN) can be used to interconnect nearby devices together, employing widely used networking protocols. The various aspects described herein can apply to any communication standard, such as Wi-Fi or, more generally, any member of the Institute of Electrical and Electronics Engineers (IEEE) 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol can be used for Internet access, sensors, metering, smart grid networks, or other wireless applications. Advantageously, aspects of certain devices implementing this particular wireless protocol can consume less power than devices implementing other wireless protocols, can be used to transmit wireless signals across short distances, and/or can be able to transmit signals less likely to be blocked by objects, such as humans.

In some implementations, a WLAN includes various devices which are the components that access the wireless network. For example, there can be two types of devices: access points (“APs”) and clients (also referred to as stations, or “STAs” 106A-106D″). In general, an AP serves as a hub or base station for the WLAN and a station (STA) serves as a user of the WLAN. For example, a STA can be a laptop computer, a personal digital assistant (PDA), a mobile phone, etc. In an example, an STA connects to an AP via a Wi-Fi (e.g., IEEE 802.11 protocol such as 802.11ax) compliant wireless link to obtain general connectivity to the Internet or to other wide area networks. In some implementations an STA can also be used as an AP.

The techniques described herein can be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to concurrently transmit data belonging to multiple user terminals. A TDMA system can allow multiple user terminals to share the same frequency channel by dividing the transmission signal into different time slots, each time slot being assigned to different user terminal. A TDMA system can implement global systems for mobile communication (GSM) or some other standards known in the art. An OFDMA system utilizes orthogonal frequency division multiplexing (OFDM), which is a modulation technique that partitions the overall system bandwidth into multiple orthogonal sub-carriers. These sub-carriers can also be called tones, bins, etc. With OFDM, each subcarrier can be independently modulated with data. An OFDM system can implement IEEE 802.11 or some other standards known in the art. An SC-FDMA system can utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein can implement the 802.11ax standard, for example. Such devices, whether used as an STA or AP or other device, can be used for smart metering or in a smart grid network. Such devices can provide sensor applications or be used in home automation. The devices can instead or in addition be used in a healthcare context, for example for personal healthcare. They can also be used for surveillance, to enable extended-range Internet connectivity (e.g., for use with hotspots), or to implement machine-to-machine communications.

Some 802.11ax devices may be configured to operate under low power conditions, and may be manufactured with relatively lower complexity components. For example, in some aspects, these less sophisticated and possibly lower cost devices may be configured to consume relatively low amounts of power and may be manufactured with less sophisticated wireless networking receivers and/or transmitters in order to reduce cost and also in some aspects to reduce power dissipation. Therefore, in some aspects, these devices may utilize a reduced frequency spectrum when transmitting and/or receiving data over a wireless network. Throughout this disclosure, these devices may be referred to as reduced bandwidth devices. For example, while some 802.11 ax devices, referred to throughout this disclosure as normal bandwidth devices, may be able to transmit and/or receive information utilizing 20 MHz, 40 MHz, 80 MHz, and/or 160 MHz frequency bands, in some aspects, the reduced bandwidth devices may be able to transmit and receive using, for example, a maximum of 20 MHz of bandwidth.

These devices may communicate with each other according to a tone plan or tone map. In some aspects, data and/or pilot tones of a transmission may be divided among any number of different users. For example, in some aspects, data and/or pilot tones may be divided among between one and eight users. In order to divide the data and/or pilot tones an access point or another device may signal to the various devices, indicating which devices may transmit or receive on which tones in a particular transmission. For example, the signaling may indicate when resource units are utilized by each device during a communication. In some aspects, the signaling may indicate a first set of tones across one or more resource units that may encode data for a communication between devices. In some aspects, the signaling may indicate a second set of tones across one or more resource units that may not be used, or in other words, may be restricted, such that they do not encode data for the communication between devices. These indications for a communication between two or more devices may be collectively referred to as a tone plan throughout this disclosure.

In some aspects, these reduced bandwidth devices may participate in an OFDMA communication by utilizing resource units that do not exceed a bandwidth limit, such as 20 MHz. For example, these reduced bandwidth devices may be limited to a certain number of tones, for example, a 242 tone resource unit in some aspects. In some aspects, these reduced bandwidth devices may process frame preambles within a primary 20 MHz band in order to obtain information indicating resource unit assignments for the device. These reduced bandwidth devices may also process a corresponding physical 20 MHz of its resource unit assignment (which may be different from the primary 20 MHz channel) when processing high efficiency long training fields as well as data symbols.

In some aspects, the less complex design of a receive component in reduced bandwidth devices may cause filtering within the receiver to null out sub-band DC tones and some edge tones in the physical 20 MHz band. Tones which cannot be accurately or reliably received by the reduced bandwidth devices may be referred to throughout this disclosure as impacted tones. For example, the receive filtering may utilize a receive filter for 802.11ax high efficiency 20 MHz, such that three DC tones in the middle of the band, six tones at the left of the band, and five guard tones in the high efficiency 20 MHz tone plan may be nulled out, and thus, these tones are impacted. Alternatively, the receive component filtering may utilize a different filter that is wider. This wider filter may cover more edge tones, such that three tones in the middle of the band, and less guard tones at the edge of the 20 MHz high efficiency tone plan are nulled out, resulting in fewer impacted tones.

In some aspects, these reduced bandwidth devices may perform communication utilizing a PPDU that has a bandwidth larger than the receive bandwidth supported by their receive components. Because these reduced bandwidth devices may include receive circuitry that is capable of receiving data within a smaller range than the PPDU bandwidth transmitted on a network, in some aspects, specific tone plans may be provided to facilitate communication with these reduced bandwidth devices simultaneously with communication of other normal bandwidth devices that can receive data over a larger bandwidth.

In some aspects, the transmission frequency spectrum may be partitioned such that reduced bandwidth devices with a limited frequency range in which to receive data are allocated a first portion of the spectrum, while normal bandwidth devices with a less limited frequency range are allocated a second different portion of the frequency spectrum, where the second portion has a greater bandwidth than the first portion, but the first and second portions do not overlap.

In some aspects, a first frequency spectrum in which the reduced bandwidth devices can receive data is also utilized by the normal bandwidth devices. In these aspects, some resource units within the first frequency spectrum may not be utilized to encode data for the reduced bandwidth devices. For example, these resource units may include tones which cannot be accurately or reliably received by the reduced bandwidth devices. These resource units may still encode data for the devices with more robust capability. In some aspects, the resource units that are not utilized to encode data for the reduced bandwidth devices may be smaller than a predetermined size, while resource units above the predetermined size encode data for both types of devices.

In some aspects, impacted tones in some resource units may be punctured when data is encoded for reduced bandwidth devices. For example, the reduced bandwidth devices may be unable to receive data encoded using certain tones (impacted tones) in certain resource units. These tones may be punctured when the data is transmitted to a less sophisticated device, but may remain unpunctured when data is encoded and transmitted to a device with more robust capability.

In some aspects, a resource unit tone plan may be adapted such that a resource unit used to encode data for a normal bandwidth device which is impacted when data is transmitted to a reduced bandwidth device, the tone plan is adapted to move encoding of the impacted data to null tones guard tones, or other resource units.

In some aspects, some encoded data (such as quadrature amplitude modulation symbols) may be transmitted using dual tones when transmitted to a reduced bandwidth device, but transmitted using only one tone when transmitted to a normal bandwidth device with more robust capabilities. For example, as discussed above, data transmitted using impacted tones may be transmitted using dual tones. In some aspects, the additional tones may include null tones, guard tones, or other unused tones. In some aspects for example, a resource unit may be reserved to encode data that was also encoded in impacted tones. Thus resource unit may not encode any data when transmitted to a normal bandwidth device.

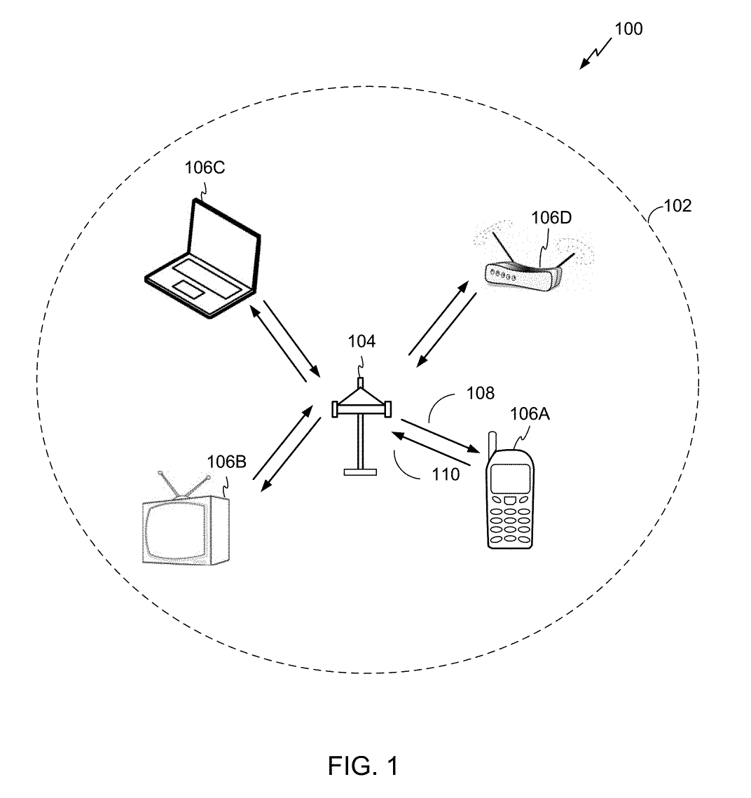

FIG. 1 illustrates an example of a wireless communication system 100 in which aspects of the present disclosure can be employed. The wireless communication system 100 can operate pursuant to a wireless standard, for example at least one of the 802.11ax, 802.11ah, 802.11ac, 802.11n, 802.11g and 802.11b standards. The wireless communication system 100 can include an AP 104, which communicates with STAs 106A-106D.

A variety of processes and methods can be used for transmissions in the wireless communication system 100 between the AP 104 and the STAs 106A-106D. For example, signals can be transmitted and received between the AP 104 and the STAs 106A-106D in accordance with OFDM/OFDMA techniques. If this is the case, the wireless communication system 100 can be referred to as an OFDM/OFDMA system. Alternatively, signals can be transmitted and received between the AP 104 and the STAs 106A-106D in accordance with code division multiple access (CDMA) techniques. If this is the case, the wireless communication system 100 can be referred to as a CDMA system.

A communication link that facilitates transmission from the AP 104 to one or more of the STAs 106A-106D 106 can be referred to as a downlink (DL) 108, and a communication link that facilitates transmission from one or more of the STAs 106A-106D to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the STAs 106A-106D associated with the AP 104 and that use the AP 104 for communication can be referred to as a basic service set (BSS). It should be noted that the wireless communication system 100 may not have a central AP 104, but rather can function as a peer-to-peer network between the STAs 106A-106D. Accordingly, the functions of the AP 104 described herein can alternatively be performed by one or more of the STAs 106A-106D.

In the disclosed methods and systems a first portion of the STAs 106A-D may be able to transmit and receive across a nominal frequency range, such as 80 MHz or 160 MHz. Another second portion of the STAs 106A-D may only be able to transmit across a narrower frequency range, for example 20 MHz. These devices may be referred to throughout this disclosure as reduced bandwidth devices. As a result of this reduced frequency range for communication, some tones that may be readily received by the first portion of STAs may not be reliably received by the second portion of STAs. Thus, some aspects of the disclosed methods and systems provide for the use of a first tone plan for communication with the first portion of STAs and a second tone plan for communication with the second portion of STAs. In some aspects, the second tone plan may be derived from the first tone plan. For example, the second tone plan may generally encode data according to the first tone plan, but encode data that would be encoded using impacted tones or impacted resource units utilizing the impacted tones in a different manner.

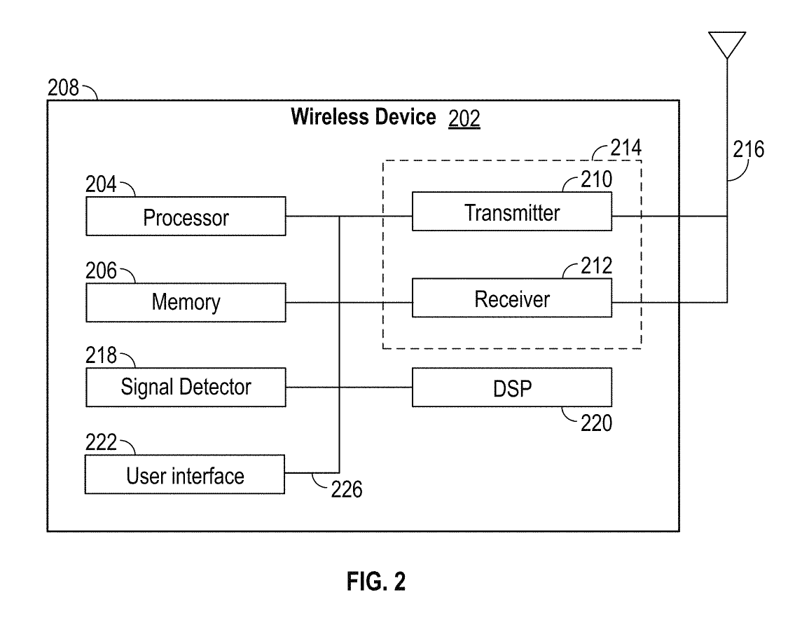

FIG. 2 illustrates various components that can be utilized in a wireless device 202 that can be employed within the wireless communication system 100. The wireless device 202 is an example of a device that can be configured to implement the various methods described herein. For example, the wireless device 202 can comprise the AP 104 or one of the STAs 106A-106D.

The wireless device 202 can include a processor 204 which controls operation of the wireless device 202. The processor 204 can also be referred to as a central processing unit (CPU). Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can comprise a PPDU. In some aspects, the PPDU is referred to as a packet.

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components are illustrated in FIG. 2, those of skill in the art will recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can comprise an AP 104 or an STA 106, and can be used to transmit and/or receive communications. The communications exchanged between devices in a wireless network can include data units which can comprise packets or frames. In some aspects, the data units can include data frames, control frames, and/or management frames. Data frames can be used for transmitting data from an AP and/or a STA to other APs and/or STAs 106A-106D. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

Certain aspects of the present disclosure support allowing APs 104 to allocate STAs 106A-106D transmissions in optimized ways to improve efficiency. Both high efficiency wireless (HEW) stations, stations utilizing an 802.11 high efficiency protocol (such as 802.11ax), and stations using older or legacy 802.11 protocols (such as 802.11b), can compete or coordinate for access to a wireless medium. In some embodiments, the high-efficiency 802.11 protocol described herein can allow for HEW and legacy stations to interoperate according to various OFDM tone plans (which can also be referred to as tone maps). In some embodiments, HEW stations can access the wireless medium in a more efficient manner. Accordingly, in the case of apartment buildings or densely-populated public spaces, APs and/or STAs 106A-106D that use the high-efficiency 802.11 protocol can experience reduced latency and increased network throughput even as the number of active wireless devices increases, thereby improving user experience.

In some embodiments, APs 104 can transmit on a wireless medium according to various DL tone plans for HEW STAs 106A-106D. For example, with respect to FIG. 1, the STAs 106A-106DA-106D can be HEW STAs 106A-106D. In some embodiments, the HEW STAs 106A-106D can communicate using a symbol duration four times that of a legacy STA. For example, in various embodiments, a 1× symbol duration can be 4 ms and a 4× symbol duration can be 16 ms. The AP 104 can transmit messages to the HEW STAs 106A-106DA-106D according to one or more tone plans, based on a communication bandwidth.

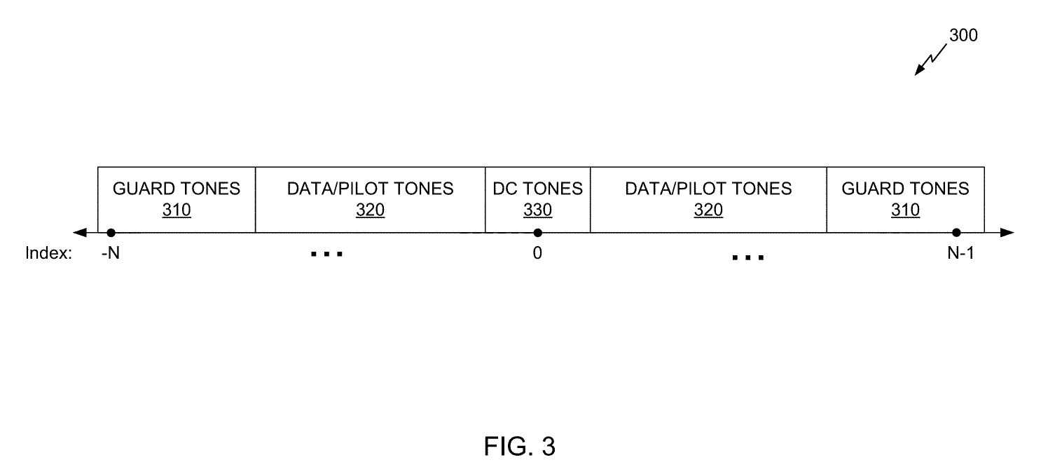

FIG. 3 shows an exemplary 2N-tone plan 300, according to one embodiment. In an embodiment, the tone plan 300 corresponds to OFDM tones, in the frequency domain, generated using a 2N-point fast Fourier transform (FFT). The tone plan 300 includes 2N OFDM tones indexed −N to N−1. The tone plan 300 includes two sets of guard tones 310, two sets of data/pilot tones 320, and a set of direct current (DC) tones 330. In various embodiments, the guard tones 310 and DC tones 330 can be null. In various embodiments, the tone plan 300 includes another suitable number of pilot tones and/or includes pilot tones at other suitable tone locations.

Although a 2N-tone plan 300 is shown in FIG. 3, similar tone plans can be used (such as 32-, 48-, 64-, 96-, 128-, 192-, 256-, 320-, 384-, 448-, 512-, 768-, 1024, 1280-, 1536-, 1792-, and 2048-tone plans). In various embodiments, each tone plan can correspond to a communication bandwidth such as, for example, 20 MHz, 40 MHz, 80 MHz, and 160 MHz. In various embodiments, 512-, 1024, and 2048-tone plans can include a 256-tone plan, repeated 2, 4, and 8 times, respectively, in the frequency domain. In one embodiment, the 256-tone plan can include the very high throughput (VHT) 80 MHz tone plan defined in an IEEE 802.11 standard.

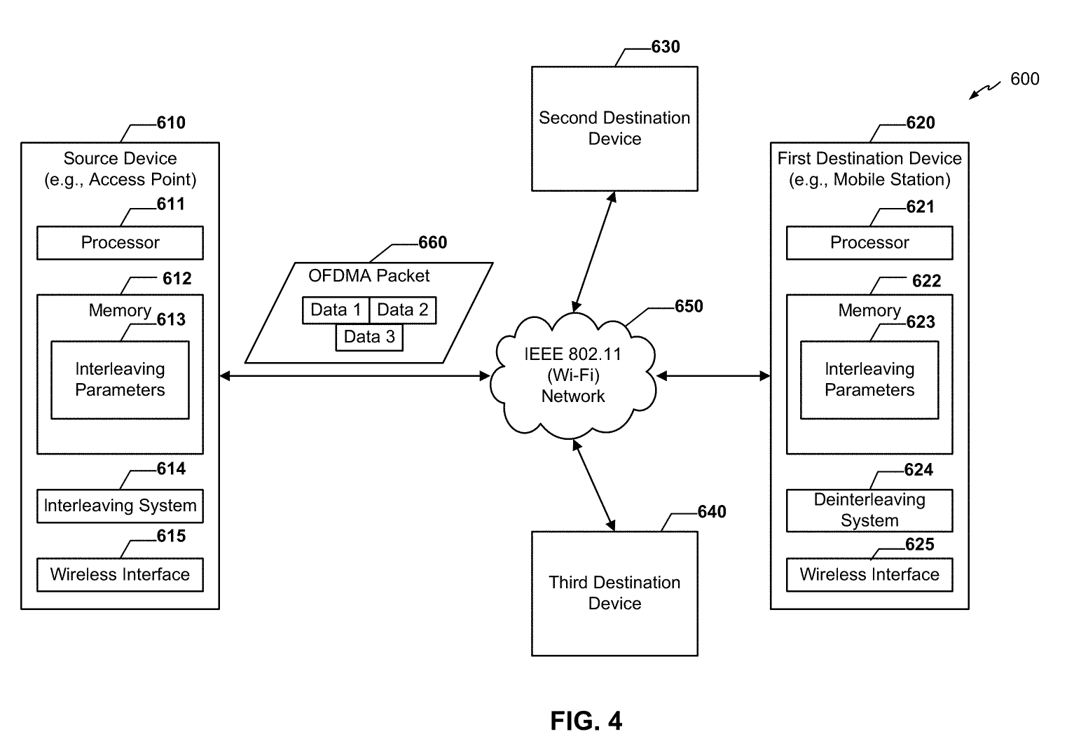

FIG. 4 shows a system 600 that is operable to generate interleaving parameters for orthogonal frequency-division multiple access (OFDMA) tone plans, according to an embodiment. The system 600 includes a first device (e.g., a source device) 610 configured to wirelessly communicate with a plurality of other devices (e.g., destination devices) 620, 630, and 640 via a wireless network 650. In alternate embodiments, a different number of source devices destination devices can be present in the system 600. In various embodiments, the source device 610 can include the AP 104 (FIG. 1) and the other devices 620, 630, and 640 can include STAs 106A-106D (FIG. 1). The system 600 can include the system 100 (FIG. 1). In various embodiments, any of the devices 610, 620, 630, and 640 can include the wireless device 202 (FIG. 2).

In a particular embodiment, the wireless network 650 is an IEEE 802.11 wireless network (e.g., a Wi-Fi network). For example, the wireless network 650 can operate in accordance with an IEEE 802.11 standard. In a particular embodiment, the wireless network 650 supports multiple access communication. For example, the wireless network 650 can support communication of a single packet 660 to each of the destination devices 620, 630, and 640, where the single packet 660 includes individual data portions directed to each of the destination devices. In one example, the packet 660 can be an OFDMA packet, as further described herein.

The source device 610 can be an access point (AP) or other device configured to generate and transmit multiple access packet(s) to multiple destination devices. In a particular embodiment, the source device 610 includes a processor 611 (e.g., a central processing unit (CPU), a digital signal processor (DSP), a network processing unit (NPU), etc.), a memory 612 (e.g., a random access memory (RAM), a read-only memory (ROM), etc.), and a wireless interface 615 configured to send and receive data via the wireless network 650. The memory 612 can store binary convolutional code (BCC) interleaving parameters 613 used by an interleaving system 614 to interleave data according to the techniques described with respect to an interleaving system 614 of FIG. 4.

As used herein, a “tone” can represent a frequency or set of frequencies (e.g., a frequency range) within which data can be communicated. A tone can alternately be referred to as a subcarrier. A “tone” can thus be a frequency domain unit, and a packet can span multiple tones. In contrast to tones, a “symbol” can be a time domain unit, and a packet can span (e.g., include) multiple symbols, each symbol having a particular duration. A wireless packet can thus be visualized as a two-dimensional structure that spans a frequency range (e.g., tones) and a time period (e.g., symbols).

As an example, a wireless device can receive a packet via an 80 megahertz (MHz) wireless channel (e.g., a channel having 80 MHz bandwidth). The wireless device can perform a 512-point FFT to determine 512 tones in the packet. A subset of the tones can be considered “useable” and the remaining tones can be considered “unusable” (e.g., can be guard tones, direct current (DC) tones, etc.). To illustrate, 498 of the 512 tones can be useable, including 474 data tones and 24 pilot tones. As another example, there can be 476 data tones and 22 pilot tones. It should be noted that the aforementioned channel bandwidths, transforms, and tone plans are for example. In alternate embodiments, different channel bandwidths (e.g., 5 MHz, 6 MHz, 6.5 MHz, 40 MHz, 80 MHz, etc.), different transforms (e.g., 256-point FFT, 1024-point FFT, etc.), and/or different tone plans can be used.

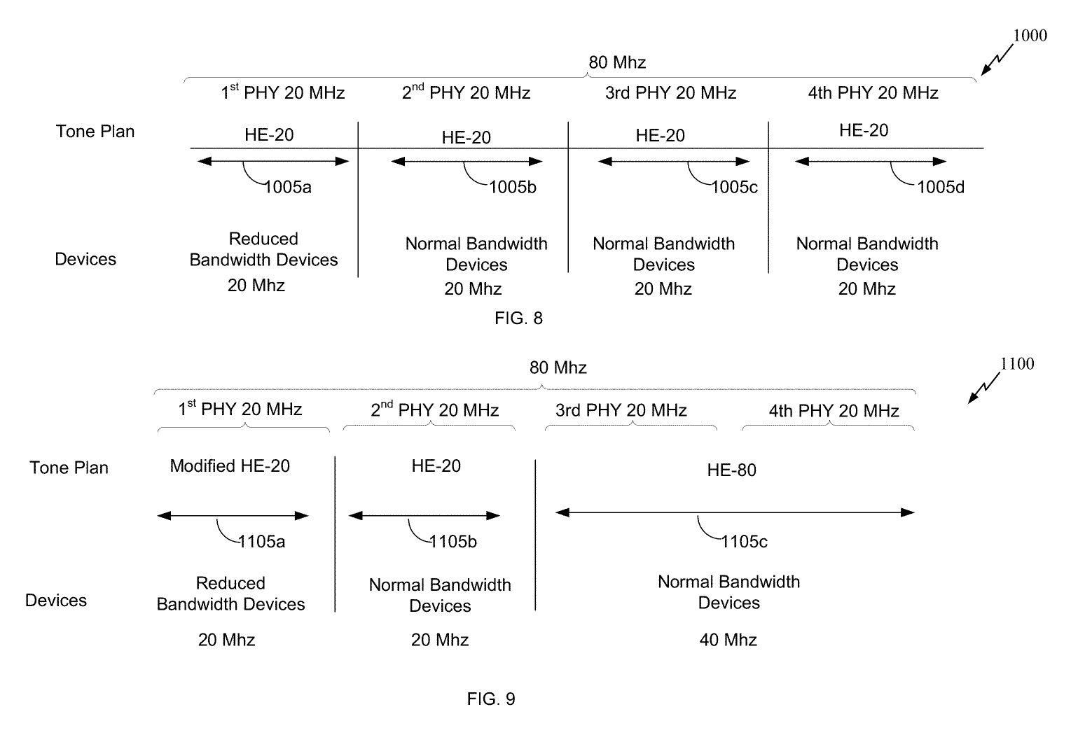

In a particular embodiment, a packet can include different block sizes (e.g., a different number of data tones per sub-band) that are transmitted over one or more spatial streams. For example, the packet can include 12 data tones per sub-band, 36 data tones per sub-band, 72 data tones per sub-band, 120 data tones per sub-band, 156 data tones per sub-band, or 312 data tones per sub-band. Interleave depths, interleave rotation indexes, and base subcarrier rotations combinations can be provided for each block size according to the chart in FIG. 8A-8B.

In a particular embodiment, the interleaving parameters 613 can be used by the interleaving system 614 during generation of the multiple access packet 660 to determine which data tones of the packet 660 are assigned to individual destination devices. For example, the packet 660 can include distinct sets of tones allocated to each individual destination device 620, 630, and 640. To illustrate, the packet 660 can utilize interleaved tone allocation.

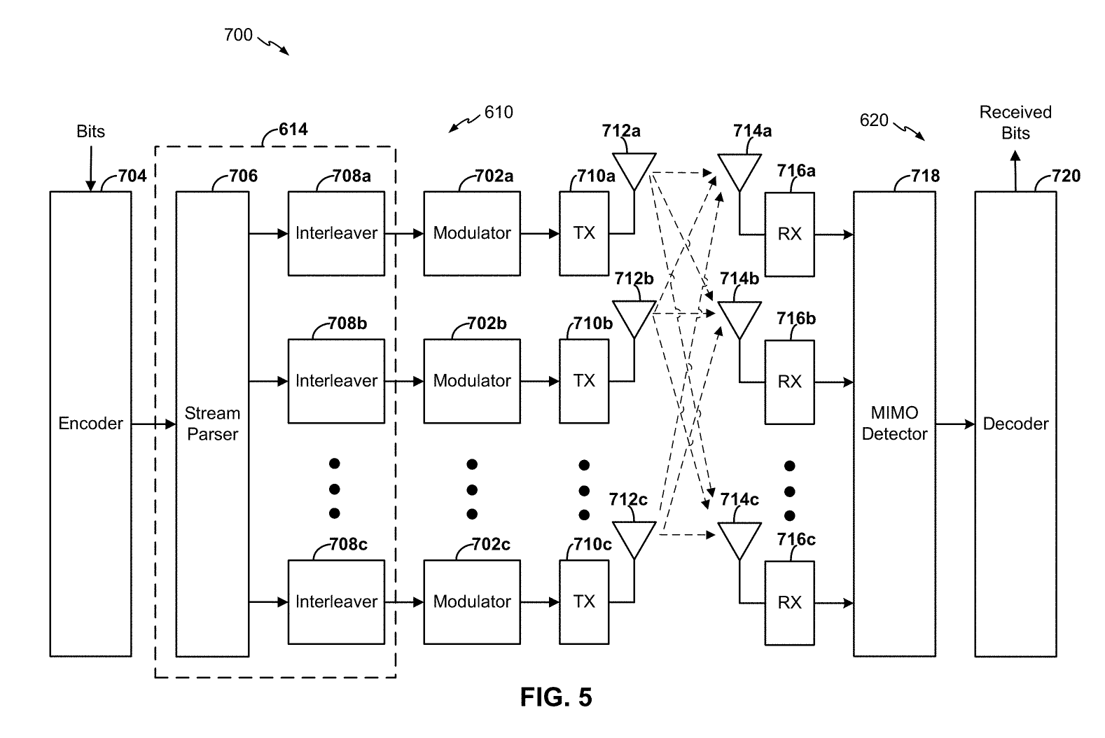

The destination devices 620, 630, and 640 can each include a processor (e.g., a processor 621), a memory (e.g., a memory 622), and a wireless interface (e.g., a wireless interface 625). The destination devices 620, 630, and 640 can also each include a deinterleaving system 624 configured to deinterleave packets (e.g., single access packets or multiple access packets), as described with reference to a MIMO detector 718 of FIG. 5. In one example, the memory 622 can store interleaving parameters 623 identical to the interleaving parameters 613.

During operation, the source device 610 can generate and transmit the packet 660 to each of the destination devices 620, 630, and 640 via the wireless network 650. The packet 660 can include distinct sets of data tones that are allocated to each individual destination device according to an interleaved pattern.

The system 600 of FIG. 4 can thus provide OFDMA data tone interleaving parameters for use by source devices and destination devices to communicate over an IEEE 802.11 wireless network. For example, the interleaving parameters 613, 623 (or portions thereof) can be stored in a memory of the source and destination devices, as shown, can be standardized by a wireless standard (e.g., an IEEE 802.11 standard), etc. It should be noted that various data tone plans described herein can be applicable for both downlink (DL) as well as uplink (UL) OFDMA communication.

For example, the source device 610 (e.g., an access point) can receive signal(s) via the wireless network 650. The signal(s) can correspond to an uplink packet. In the packet, distinct sets of tones can be allocated to, and carry uplink data transmitted by, each of the destination devices (e.g., mobile stations) 620, 630, and 640.

FIG. 5 shows an exemplary multiple-input-multiple-output (MIMO) system 700 that can be implemented in wireless devices, such as the wireless device of FIG. 4, to transmit and receive wireless communications. The system 700 includes the first device 610 of FIG. 4 and the destination device 620 of FIG. 4.

The first device 610 includes an encoder 704, the interleaving system 614, a plurality of modulators 702a-702c, a plurality of transmission (TX) circuits 710a-710c, and a plurality of antennas 712a-712c. The destination device 620 includes a plurality of antennas 714a-714c, a plurality of receive (RX) circuits 716a-716c, a MIMO detector 718, and a decoder 720.

A bit sequence can be provided to the encoder 704. The encoder 704 can be configured to encode the bit sequence. For example, the encoder 704 can be configured to apply a forward error correcting (FEC) code to the bit sequence. The FEC code can be a block code, a convolutional code (e.g., a binary convolutional code), etc. The encoded bit sequence can be provided to the interleaving system 614.

The interleaving system 614 can include a stream parser 706 and a plurality of spatial stream interleavers 708a-708c. The stream parser 706 can be configured to parse the encoded bit stream from the encoder 704 to the plurality of spatial stream interleavers 708a-708c.

Each interleaver 708a-708c can be configured to perform frequency interleaving. For example, the stream parser 706 can output blocks of coded bits per symbol for each spatial stream. Each block can be interleaved by a corresponding interleaver 708a-708c that writes to rows and reads out columns. The number of columns (NCOL), or the interleaver depth, can be based on the number of data tones (Ndata), as described with respect to the table of FIGS. 8A-8B. The number of rows (NROW) can be a function of the NCOL and Ndata. For example, the number of rows (NROW) can be equal to Ndata divided by NCOL (e.g., NROW=Ndata/NCOL).

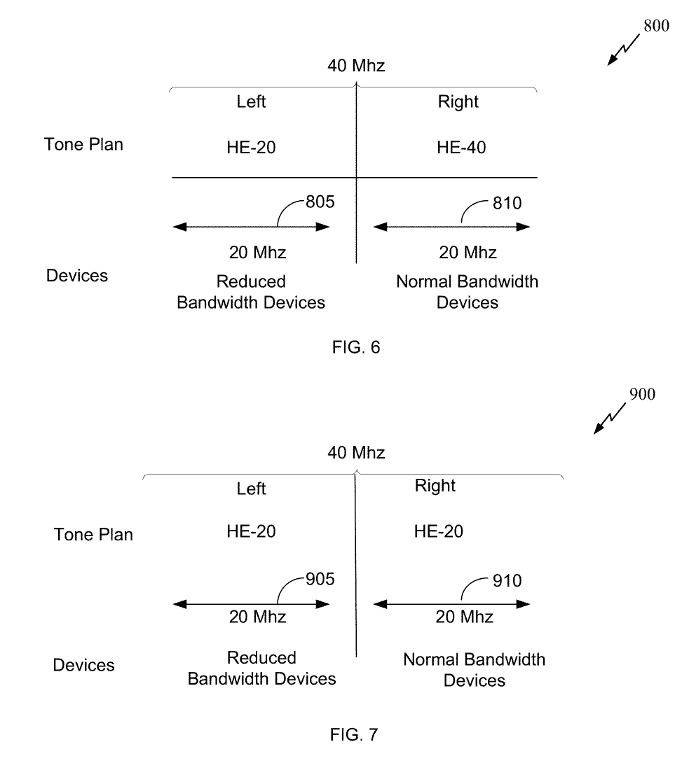

FIG. 6 shows use of different tone plans to support communication with both reduced bandwidth devices and normal bandwidth devices in an operative embodiment. As shown in FIG. 6, in some aspects, a device, such as an access point, communicates with a set of devices utilizing a 40 MHz frequency bandwidth. The set of devices may include reduced bandwidth devices and normal bandwidth devices. In the illustrated embodiment, the device, such as an access point, may utilize a first portion of the 40 MHz bandwidth 805 to communicate with the reduced bandwidth devices. This first portion 805 may utilize the HE-20 tone plan of 802.11ax in the first 20 MHz portion 805 when communicating with the reduced bandwidth devices. To communicate with the normal bandwidth devices, the device may utilize a HE-40 tone plan of 802.11ax. Since the device is communicating with the normal bandwidth devices in only the second portion 810, the device may utilize the portion of the HE-40 tone plan appropriate for the portion of the frequency spectrum 810. The other half of the HE-40 tone plan may not be utilized in this embodiment. Note that the portions 805 and 810 could be reversed from that shown in FIG. 6, in that FIG. 6 could represent a lower (or higher) frequency spectrum than portion 805 in some aspects.

FIG. 7 shows use of tone plans to support communication with both reduced bandwidth devices and normal bandwidth devices in an operative embodiment. FIG. 7 illustrates use of a 40 MHz frequency bandwidth to communicate with both reduced bandwidth devices and normal bandwidth devices. In the embodiment of FIG. 7, the device, such as an access point, communicates with the reduced bandwidth devices using a first portion of the 40 MHz frequency bandwidth 905, and communicates with the normal bandwidth devices using a second portion of the 40 MHz frequency bandwidth 910. In the embodiment of FIG. 7, an 802.11ax HE-20 tone plan is utilized to communicate with the reduced bandwidth devices in portion 905, while the same 802.11ax HE-20 tone plan is utilized to communicate with normal bandwidth devices in portion 910. In some aspects, the relative positions of portions 905 and 910 may be reversed from that shown.

FIG. 8 shows use of tone plans to support communication with both reduced bandwidth devices and normal bandwidth devices in an operative embodiment. FIG. 8 illustrates use of a shared 80 MHz frequency bandwidth to communicate with both reduced bandwidth devices and normal bandwidth devices. In the embodiment of FIG. 8, a device, such as an access point, may utilize the 802.11ax HE-20 tone plan in each of four 20 MHz bandwidths 1005a-d of the shared 80 MHz frequency bandwidth. One of the four 20 MHz bandwidths 1005a-d may be used to communicate with reduced bandwidth devices, while the remaining three portions may be used to communicate with normal bandwidth devices. In some aspects, the relative positions of portions 1005a-d may be different from that shown. In various embodiments, any arrangement of portions 1005a-d within the 80 MHz bandwidth is contemplated.

FIG. 9 shows use of tone plans to support communication with both reduced bandwidth devices and normal bandwidth devices in an operative embodiment. FIG. 9 illustrates use of a shared 80 MHz frequency bandwidth to communicate with both reduced bandwidth devices and normal bandwidth devices. In the embodiment of FIG. 9, a device, such as an access point, may utilize a modified form of the 802.11ax HE-20 tone plan to communicate within portion 1105a with reduced bandwidth devices. This modified form of the HE-20 tone plan may, in some aspects, avoid use of resource units within the HE-20 tone plan that include impacted tones with respect to the reduced bandwidth devices. In some embodiments, this modified form of the HE-20 tone plan may puncture impacted tones for the reduced bandwidth devices within the HE-20 tone plan. In some embodiments, the modified tone plan may move coding for data that would otherwise utilize the impacted tones to other tones, such as edge tones or null tones. The device may utilize the 802.11ax HE-20 tone plan to communicate with normal bandwidth devices within a second 20 Mhz portion 1105b of the 80 MHz spectrum. The device may utilize the 802.11 ax HE-80 tone plan within a third 40 Mhz portion 1105c of the 80 MHz bandwidth to also communicate with normal bandwidth devices. In some embodiments, the portion 1105c may occupy the first 40 MHz of the 80 MHz spectrum (the first and 2^{nd} phy 20 Mhz portions), with the reduced bandwidth devices serviced in the fourth phy 20 MHz portion of the spectrum. Portion 1105b would occupy the third phy 20 MHz frequency portion (from the left) of the 80 MHz spectrum in this embodiment.

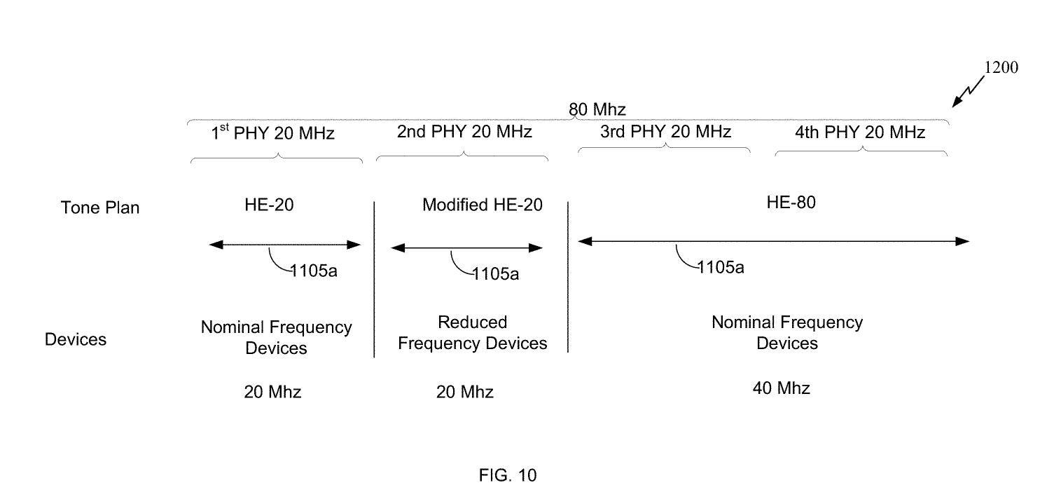

FIG. 10 shows use of tone plans to support communication with both reduced bandwidth devices and normal bandwidth devices in an operative embodiment. FIG. 10 illustrates use of a shared 80 MHz frequency bandwidth to communicate with both reduced bandwidth devices and normal bandwidth devices. In the embodiment of FIG. 10, a device, such as an access point, may utilize a modified form of the 802.11ax HE-20 tone plan to communicate within a 20 MHz portion 1105b with reduced bandwidth devices. This modified form of the HE-20 tone plan may, in some aspects, avoid use of resource units within the HE-20 tone plan that include impacted tones with respect to the reduced bandwidth devices. In some embodiments, this modified form of the HE-20 tone plan may puncture impacted tones for the reduced bandwidth devices within the HE-20 tone plan. In some embodiments, the modified tone plan may move coding for data that would otherwise utilize the impacted tones to other tones, such as edge tones or null tones. The device may utilize the 802.11ax HE-20 tone plan to communicate with normal bandwidth devices within a second portion 1105a of the 80 MHz spectrum. The device may utilize the 802.11 ax HE-80 tone plan within a third portion 1105c of the 80 MHz bandwidth to also communicate with normal bandwidth devices. In an alternative embodiment, the reduced bandwidth devices and thus the modified HE-20 tone plan may be utilized within a third phy 20 MHz portion (from the left) of the 80 MHz bandwidth. In these embodiments, the HE-80 tone plan may be utilized in the lowest frequency half portion of the 80 MHz spectrum (1^{st} and 2^{nd} phy 20 Mhz portions), with the 802.11ax HE-20 tone plan utilized in the highest frequency 20 megahertz portion of the 80 MHz spectrum (the 4^{th} phy 20 Mhz portion).

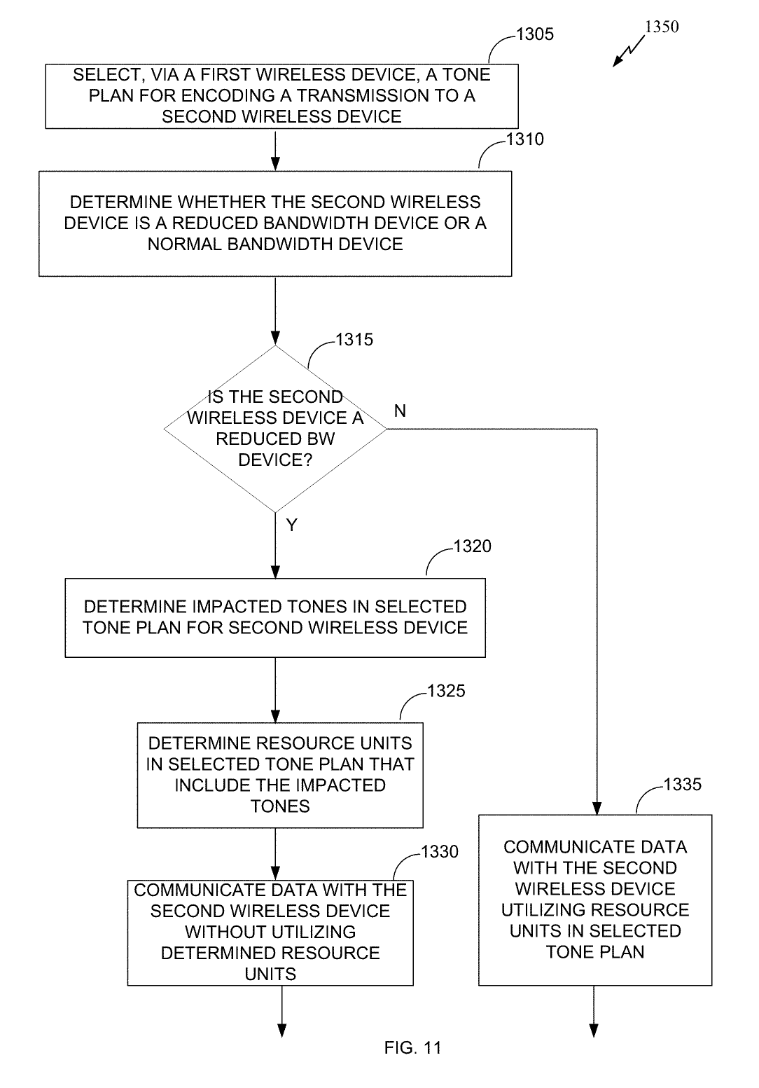

FIG. 11 is a flowchart for a method of encoding data for devices based on a receive frequency range of each of the devices. In some aspects, the process 1300 may be performed by the wireless device 202.

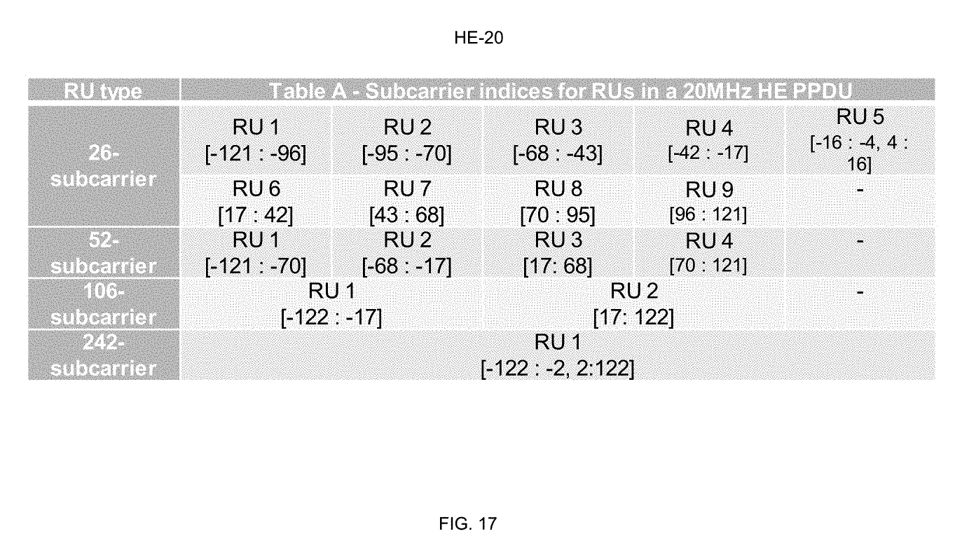

In block 1305, a first wireless device selects a tone plan for transmission to a second wireless device. In some embodiments, the tone plan selected may be one of an 802.11ax HE-20, HE-40, or HE-80 tone plan for example, as described below in FIGS. 17-19. In some aspects, the tone plan is selected according to one of the embodiments described in FIGS. 8-12 above.

Block 1310 determines whether the second wireless device is a reduced bandwidth device or a normal bandwidth device. In some aspects, this determination may be based on capabilities information provided during an association process between the first and second wireless devices.

If the second wireless device is not a reduced bandwidth device, then process 1300 moves to block 1335, where data communication with the second wireless device exchanges data with the second wireless device. In some aspects, communicating with the second wireless device includes encoding the data according to the selected tone plan and transmitting the data. For example, in some aspects, all the resource units defined by the selected tone plan may be utilized when transmitting information to the second wireless device. In other aspects, communication with the second wireless device may include receiving the data from the second wireless device according to the selected tone plan.

If the second wireless device is a reduced bandwidth device, block 1320 determines impacted tones in the selected tone plan for the second wireless device. If the tone plan selected in block 1305 is the 802.11ax HE-40 tone plan, and the reduced bandwidth devices utilize resource units in the left physical 20 MHz, tones {−129, −128, −127} (in the 5th 26-tone RU) may fall into a reduced bandwidth devices receiver's DC in filtering, and tones {−5, −4} (in 9th 26-tone RU, 4th 52-tone RU, 2nd 106-tone RU, 1st 242-tone RU) may fall into the receiving devices guard band in filtering (depending on filter design). Thus, these tones may be determined to be impacted in some embodiments.

If the tone plan selected in block 1305 is the 802.11ax HE-40 tone plan, and the reduced bandwidth devices utilize resource units in the right physical (PHY) 20 MHz, tones {+127, +128, +129} (in the 14th 26-tone RU) may fall into a reduced bandwidth devices receiver's DC in filtering, and tones {+4, +5} (in 10th 26-tone RU, 5th 52-tone RU, 3rd 106-tone RU, 2nd 242-tone RU) may fall into the receivers guard band in filtering (depending on filter design). Thus, these tones may be determined to be impacted in some embodiments. If a receiver in a reduced bandwidth device utilizes wider filtering than the analysis above assumes, then the impacted tones may not include tones −5, −4, +4, +5.

If the tone plan selected in block 1305 is the 802.11ax HE-80 tone plan, and the reduced bandwidth devices will perform communication within the 1^{st} physical 20 MHz of the 80 MHz transmission bandwidth, then the impacted tones may include tones −385, −384, and −383 in the 5^{th} 26 tone resource unit and the 1^{st} 242 tone resource unit. These tones may be impacted as they may fall into a receivers DC in filtering. Tones −259 in the 1^{st} 242 tone resource unit, tone −260 and −261 in the 9^{th} 26 tone resource unit, 4^{th} 52 tone resource unit, 2^{nd} 106 tone resource unit, 1^{st} 242 tone resource unit may fall into the receivers guard band in filtering. The impacted tones may depend on specific filtering design of the receiver in the reduced bandwidth device.

If the tone plan selected in block 1305 is the 802.11ax HE-80 tone plan, and the reduced bandwidth devices will perform communication within the 2^{nd} PHY 20 MHz: tones {−129, −128, −127} (in 14^{th} 26-tone RU, 2^{nd} 242-tone RU) falls into a receivers DC in filtering, and tones {−4, −5} (in 19^{th} 26-tone RU), {−251, −252, −253, −254, −255, −256, −257} (in 10^{th} 26-tone RU, 5^{th} 52-tone RU, 3^{rd} 106-tone RU, 2^{nd} 242-tone RU), −258 (in 2^{nd} 242-tone RU) may fall into a receiver's guard band in filtering (depending on filter design). Thus, these tones may be determined to be impacted in these aspects of block 1320.

If the tone plan selected in block 1305 is the 802.11ax HE-80 tone plan, and the reduced bandwidth devices will perform communication within the 3^{rd} PHY 20 MHz: tones {+127, +128, +129} (in 24^{th} 26-tone RU, 3^{rd} 242-tone RU) falls into a receivers DC in filtering, and tones {+4, +5} (in 19^{th} 26-tone RU), {+251, +252, +253, +254, +255, +256, +257} (in 28^{th} 26-tone RU, 12^{th} 52-tone RU, 6^{th} 106-tone RU, 3^{rd} 242-tone RU), +258 (in 3^{rd} 242-tone RU) may fall into the receivers guard band in filtering (depending on filter design). Thus, these tones may be determined to be impacted in these aspects of block 1420.

If the tone plan selected in block 1305 is the 802.11ax HE-80 tone plan, and the reduced bandwidth devices will perform communication within the 4^{th} PHY 20 MHz: tones {+383, +384, +385} (in 33^{rd} 26-tone RU, 4^{th} 242-tone RU) falls into a receivers DC in filtering, and tones +259 (in 4^{th} 242-tone RU), {+260, +261} (in 29^{th} 26-tone RU, 13^{th} 26-tone RU, 7^{th} 106-tone RU, 4^{th} 242-tone RU) may fall into the receivers guard band in filtering (depending on filter design). When using the 802.11ax HE-80 tone plan, a reduced bandwidth device receiver design utilizing wider filtering than assumed in the analysis above may not impact tones ±4, ±5, ±251, ±252, ±253, ±254, ±259, ±260, ±261.

If the tone plan selected in block 1305 is an 802.11 ax HE-20 tone plan or a 802.11 ax HE-40 tone plan, and the reduced bandwidth devices perform communication within the 20 Mhz tones, the reduced bandwidth devices may provide tone mapping in one or more of the 26-tone RU, 52-tone RU, 106-tone RU, and the 242 tone RU. The tone mapping may be performed for one or more of 2.4 Ghz and 5 Ghz frequency bands.

In the tone plan selected in block 1305 is an 802.11 ax HE-80 Mhz, 80-plus-80 Mhz, or 160 Mhz tone plan, and the reduced bandwidth devices perform communication within a 20 Mhz bandwidth of the selected tone plan, then the reduced bandwidth devices may provide tone mapping for one or more of the 26 tone RU, 52 tone RU, 106 tone RU, and 242 tone RU. This tone mapping may be performed for the 5 Ghz frequency band in some aspects.

Block 1325 determines resource units within the selected tone plan that include the impacted tones. In aspects utilizing the HE-40 tone plan, this may include from left to right, the 5^{th}, 9^{th}, 10^{th}, 14^{th} 26 tone resource units, the 4^{th}, 5^{th} 52 tone resource units, the 2^{nd} and 3^{rd} 106 tone resource units, and the 1^{st} and 2^{nd} 242 tone resource units. Other resource units may be used for encoding in some aspects.

In aspects selecting the HE-80 tone plan in block 1305, the determined resource units may be from left to right, the 5^{th}, 9^{th}, 10, 14^{th}, 19^{th}, 24^{th}, 28^{th}, 29^{th}, 33^{rd} 26 tone resource units, the 4^{th}, 5^{th}, 12^{th}, 13^{th}, 52 tone resource units, the 2^{nd}, 3^{rd}, 6^{th}, 7^{th} 106 tone resource units, and the four 242 tone resource units. Other resource units may be used for encoding in some aspects. In some aspects transmitting over an 160 Mhz bandwidth, the HE-80 tone plan may be utilized in a lower 80 Mhz portion of the 160 Mhz bandwidth and may be duplicated in an upper 80 Mhz portion of the 160 Mhz bandwidth. In some aspects, the two 80 Mhz portions utilized for transmission may not be contiguous, and thus may span larger than a 160 Mhz bandwidth. These aspects that utilize two non-contiguous 80 Mhz portions may be referred to herein as an 80+80 Mhz bandwidth.

In block 1330, data is communicated with the second wireless device using the selected tone plan, but without utilizing the determined resource units that include the impacted tones. In some aspects, some of the resource units including impacted tones may be used. For example, in some aspects utilizing the HE-80 Mhz tone plan, the 2^{nd}, and 7^{th} 106 tone resource units and the 1^{st} and 4^{th} 242 tone resource units may still be utilized, even though they were determined to be impacted in block 1325. In some other aspects, only the 5^{th}, 10^{th}, 14^{th}, 24^{th}, 28^{th}, and 33^{rd} 26 tone resource units and the 5^{th} and 12^{th} 52 tone resource units may be excluded from use when transmitting data to the second wireless device. Note that in some aspects, performance of block 1330 may alter the tone plan selected in block 1305 such that it is essentially a different, second tone plan. The second tone plan may be largely based on the tone plan selected in block 1305, but with the impacted resource units effectively going unused when transmitting to the reduced bandwidth devices. In various aspects, communicating data in block 1330 may include transmitting the data to the second device or receiving the data from the second device.

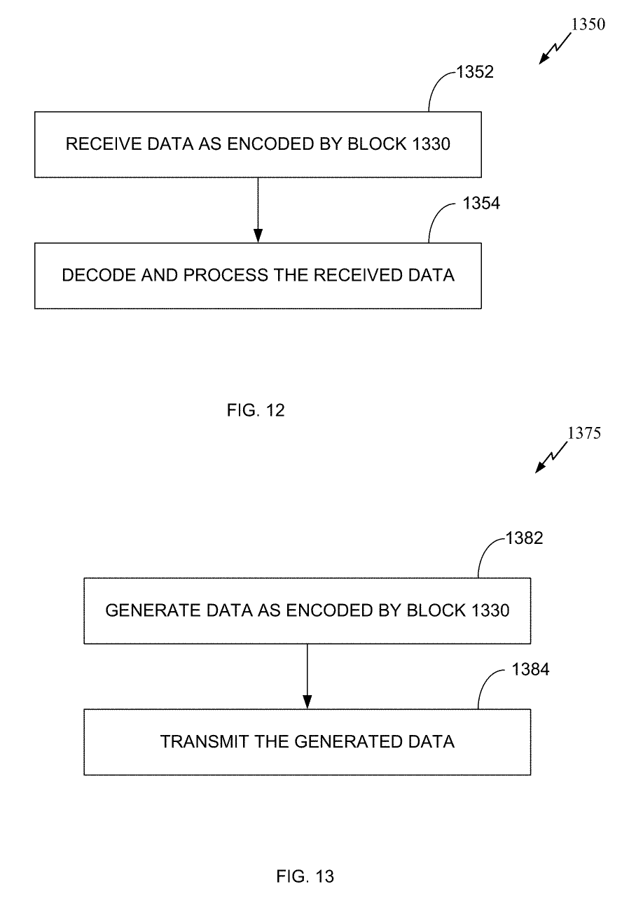

FIG. 12 is a flowchart for a method of decoding data encoded by block 1330 of FIG. 11. In some aspects, the process 1350 may be performed by the wireless device 202.

Note that while FIG. 11 shows functions that may be performed by a device communicating data according to the tone plans described above, aspects including devices transmitting data or receiving and decoding data are also contemplated. For example, to the extent particular tones or resource units are unused relative to an 802.11ax tone plan, a receiving device will selectively ignore those tones and/or resource units. In other words, a receiving device may not rely on those tones or resource units when decoding data encoded in the received frame.

In block 1352, a frame encoded and transmitted by block 1330 of FIG. 11 may be received. Thus, the frame received in block 1352 may have any of the characteristics or attributes described above with respect to FIG. 11.

In block 1354, the received frame is decoded according to the encoding described above with respect to FIG. 11 and the decoded data is processed. In some aspects, processing the data may include passing data encoded in the frame to an application program, such as a cell phone application, video streaming application, text messaging application, or other applications known in the art.

FIG. 13 is a flowchart for a method of transmitting data encoded by block 1330 of FIG. 11. In some aspects, the process 1375 may be performed by the wireless device 202.

Note that while FIG. 13 shows functions that may be performed by a device transmitting data according to the tone plans described above, aspects including devices receiving and decoding the transmitted data are also contemplated. For example, to the extent particular tones or resource units are unused relative to an 802.11ax tone plan, a receiving device will selectively ignore those tones and/or resource units. In other words, a receiving device may not rely on those tones or resource units when decoding data encoded in the received frame.

In block 1382, a frame encoded by block 1330 of FIG. 11 may be generated. Thus, the frame generated in block 1382 may have any of the characteristics or attributes described above with respect to FIG. 11.

In block 1384, the generated frame is transmitted on a network.

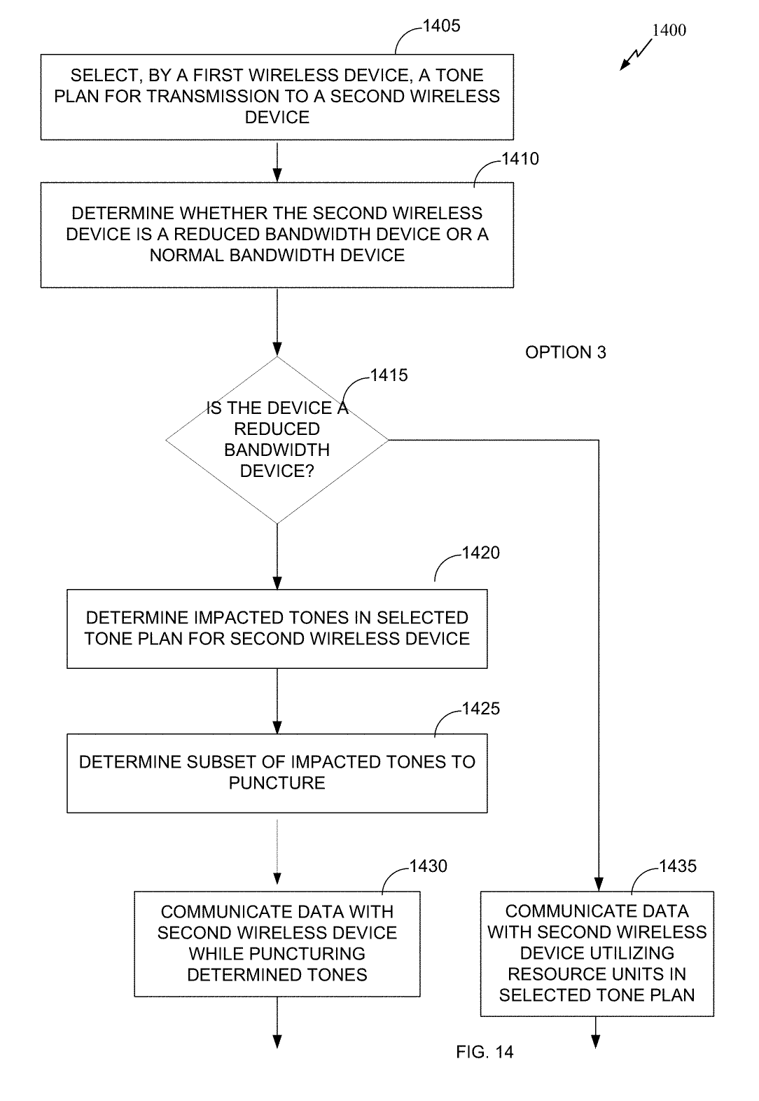

FIG. 14 is a flowchart for a method of encoding data for devices based on a receive frequency range of each of the devices. In some aspects, the process 1400 may be performed by the wireless device 202. For example, in some aspects, memory 206 may store instructions that configure the processor 204 to perform one or more of the functions discussed below with respect to FIG. 14.

In block 1405, a first wireless device selects a tone plan for transmission to a second wireless device. In some embodiments, the tone plan selected may be one of an 802.11ax HE-20, HE-40, or HE-80 tone plan, for example, as described below in FIGS. 17-19. In some aspects, the tone plan is selected according to one of the embodiments described in FIGS. 6-10 above.

Block 1410 determines whether the second wireless device is a reduced bandwidth device or a normal bandwidth device. In some aspects, this determination may be based on capabilities information provided during an association process between the first and second wireless devices.

If the second wireless device is not a reduced bandwidth device, then process 1400 moves to block 1435, where data for the second wireless device is communicated according to the selected tone plan. In some aspects, communicating the data may include encoding the data according to the selected tone plan and transmitting the data. For example, in some aspects, all tones and/or resource units of the selected tone plan may be used when transmitting data to the second wireless device in block 1435. If the second wireless device is a reduced bandwidth device, the block 1420 determines impacted tones in the selected tone plan for the second wireless device. In some other aspects, communicating the data may include receiving the data and decoding the received data according to the selected tone plan.

If the tone plan selected in block 1405 is the 802.11ax HE-40 tone plan, and the reduced bandwidth devices utilize resource units in the left PHY 20 MHz, tones {−129, −128, −127} (in the 5th 26-tone resource unit) may fall into the reduced bandwidth devices receiver's DC in filtering, and tones {−5, −4} (in the 9th 26-tone RU, 4th 52-tone RU, 2nd 106-tone RU, 1st 242-tone RU) may fall into the reduced bandwidth devices receiver's guard band in filtering (depending on filter design). Thus, these tones may be determined to be impacted in some embodiments.

If the tone plan selected in block 1405 is the 802.11ax HE-40 tone plan, and the reduced bandwidth devices utilize resource units in the right PHY 20 MHz, tones {+127, +128, +129} (in the 14th 26-tone RU) may fall into a receivers DC in filtering, and tones {+4, +5} (in 10th 26-tone RU, 5th 52-tone RU, 3rd 106-tone RU, 2nd 242-tone RU) may fall into the receivers guard band in filtering (depending on filter design). Thus, these tones may be determined to be impacted in some embodiments. If a receiver in a reduced bandwidth device utilizes wider filtering than the analysis above assumes, then the impacted tones may not include tones −5, −4, +4, +5.

If the tone plan selected in block 1405 is the 802.11ax HE-80 tone plan, and the reduced bandwidth devices will perform communication within the 1^{st} physical 20 MHz of the 80 MHz transmission bandwidth, then the impacted tones may include tones −385, −384, and −383 in the 5^{th} 26 tone resource unit and the 1^{st} 242 tone resource unit. These tones may be impacted as they may fall into a receivers DC in filtering. Tones −259 in the 1^{st} 242 tone resource unit, tone −260 and −261 in the 9^{th} 26 tone resource unit, 4^{th} 52 tone resource unit, 2^{nd} 106 tone resource unit, 1^{st} 242 tone resource unit may fall into the receivers guard band in filtering. The impacted tones may depend on specific filtering design of the receiver in the reduced bandwidth device.

If the tone plan selected in block 1405 is the 802.11ax HE-80 tone plan, and the reduced bandwidth devices will perform communication within the 2^{nd} PHY 20 MHz: tones {−129, −128, −127} (in 14^{th} 26-tone RU, 2^{nd} 242-tone RU) falls into a receivers DC in filtering, and tones {−4, −5} (in 19^{th} 26-tone RU), {−251, −252, −253, −254, −255, −256, −257} (in 10^{th} 26-tone RU, 5^{th} 52-tone RU, 3^{rd} 106-tone RU, 2^{nd} 242-tone RU), −258 (in 2^{nd} 242-tone RU) may fall into a receiver's guard band in filtering (depending on filter design). Thus, these tones may be determined to be impacted in these aspects of block 1420.

If the tone plan selected in block 1405 is the 802.11ax HE-80 tone plan, and the reduced bandwidth devices will perform communication within the 3^{rd} PHY 20 MHz: tones {+127, +128, +129} (in 24^{th} 26-tone RU, 3^{rd} 242-tone RU) falls into a receivers DC in filtering, and tones {+4, +5} (in 19^{th} 26-tone RU), {+251, +252, +253, +254, +255, +256, +257} (in 28^{th} 26-tone RU, 12^{th} 52-tone RU, 6^{th} 106-tone RU, 3^{rd} 242-tone RU), +258 (in 3^{rd} 242-tone RU) may fall into the receivers guard band in filtering (depending on filter design). Thus, these tones may be determined to be impacted in these aspects of block 1420.

If the tone plan selected in block 1405 is the 802.11ax HE-80 tone plan, and the reduced bandwidth devices will perform communication within the 4^{th} PHY 20 MHz: tones {+383, +384, +385} (in 33^{rd} 26-tone RU, 4^{th} 242-tone RU) falls into a receivers DC in filtering, and tones +259 (in 4^{th} 242-tone RU), {+260, +261} (in 29^{th} 26-tone RU, 13^{th} 26-tone RU, 7^{th} 106-tone RU, 4^{th} 242-tone RU) may fall into the receivers guard band in filtering (depending on filter design). When using the 802.11ax HE-80 tone plan, a reduced bandwidth device receiver design utilizing wider filtering than assumed in the analysis above may not impact tones ±4, ±5, ±251, ±252, ±253, ±254, ±259, ±260, ±261.

Block 1425 determines a subset of impacted tones to puncture. In some aspects, the subset determined in block 1425 is all the tones determined in block 1420. In some aspects of process 1400, block 1425 is not performed. In some aspects, the determination of a subset in block 1425 is based on a position of the impacted tones within a resource unit of the selected tone plan.

For example, in some aspects utilizing the HE-40 tone plan, in some aspects, only tones −129, −128, −127, +127, +128, and +129 are punctured. In some aspects utilizing the HE-80 tone plan, impacted tones in the 2^{nd}, 7^{th} 106 tone resource units and the 1^{st} and 4^{th} 242 tone resource units are not punctured, and thus the subset determined in block 1425 does not include these tones. In other aspects selecting the HE-80 tone plan in block 1405, only impacted tones in the 5th, 10th, 14th, 24th, 28th, 33rd 26-tone resource units and the 5th and 12th 52-tone resource units are punctured.

Block 1430 communicates data with the second wireless device using the selected tone plan, while puncturing the determined tones. As used here, puncturing tones indicates that those tones are unavailable for encoding data in a resource unit when data is encoded. Thus, for example, a resource unit with 26 tones in the selected tone plan, with three impacted tones, may only have 23 tones available for encoding data in block 1430 in some aspects (assuming all impacted tones are punctured). In these aspects, a Binary Convolutional Code (BCC) interleaver/low density parity check (LDPC) tone mapping may be utilized, such as in a 26-tone resource unit with skipping tones.

In some aspects, block 1430 may utilize additional tones to encode data not called for by the tone plan selected in block 1405. For example, block 1430 may replace the impacted tones determined in either block 1420 or 1425 with tones in other locations, such as null tones, and/or guard tones. In aspects of block 1430 that transmit data to the second wireless device, data for the second device may then be encoded and transmitted with these replacement tones in block 1430. In aspects of block 1430 that receive the data from the second wireless device, decoding of the data after reception may decode the replacement tones to interpret the received data.

For example, in some aspects selecting the 802.11ax HE-40 tone plan, for 5^{th} and 14^{th} 26-tone resource units in the HE-40 tone plan, impacted tones ±127, ±128, and ±129 may be replaced by null tones ±110, ±137, and ±244. In some aspects, for 9^{th} and 10^{th} 26 tone resource units, and 4^{th} and 5^{th} 52 tone resource units, impacted tones ±4, ±5 may be replaced with null tones ±56 and ±57. In some aspects, for 2^{nd} and 3^{rd} 106-tone resource units, and 1^{st} and 2^{nd} 242 tone resource units, impacted tones ±4 and ±5 may be replaced by guard tones ±245 and ±246. In some aspects, a subset of the replacements described above may be performed. For example, in some aspects, only impacted tones in 26 and 52 tone resource units are replaced as described above, but impacted tones within 106 and 242 tone resource units are not replaced. In some other embodiments, impacted tones in the 5^{th} and 14^{th} 26 tone resource units are replaced, but no other impacted tones are replaced.

In some aspects selecting the 802.11ax HE-80 tone plan, within the 5th and 33rd 26-tone resource units: tones ±383, ±384, ±385 may be replaced with null tones ±366, ±393, ±500. Within the 14th and 24th 26-tone resource units: tones ±127, ±128, ±129 may be replaced with null tones ±17, ±124, ±151. Within the 9th and 29th 26-tone resource units, and 4th and 13th 52-tone resource units: tones ±260, ±261 may be replaced with null tones ±312, ±313. Within the 10th and 28th 26-tone resource units and the 5th and 12th 52-tone resource units: tones ±256, ±257 may be replaced with null tones ±204, ±205 and then up to 5 tones (±251, ±252, ±253, ±254, ±255) may be punctured. In some aspects, within the 19th 26-tone RU: tones ±4, ±5 may be punctured if this RU is used; alternatively, this resource unit may be encoded according to the tone plan selected in block 1405. In some aspects, within the 3rd and 6th 106-tone resource units, and within the 2nd and 3rd 242-tone resource units, the impacted tones may be punctured. Alternatively, these resource units may be utilized as defined by the tone plan selected in block 1405.

Some aspects may substitute up to 6 impacted tones in the 2^{nd} and 7^{th} 106-tone resource units, the 1^{st} and 4^{th} 242-tone resource units, such as tones ±252, ±253, ±254, ±255, ±256, ±257) may be substituted with guard tones ±501, ±502, ±503, ±504, ±505, ±506. In some other aspects, only tones ±255, ±256, ±257 may be substituted with tones ±501, ±502, ±503. In some other aspects, only tones ±256, ±257 may be substituted with tones ±501, ±502. In some other aspects, no tones may be substituted. In some aspects, a center 26-tone resource unit (19th 26-tone RU), may be relocated within the tone plan such that the 10th and 28th 26-tone resource units, 5th and 12th 52-tone resource units, and 106- and 242-tone resource units could move data tones in it.

In some other aspects selecting the HE-80 tone plan in block 1405, the data is moved to the substituted tones as described above, except that the 2^{nd} and 7^{th} 106 tone resource units and the 1^{st} and 4^{th} 242 tone resource units are not moved. In some other aspects selecting the HE-80 tone plan in block 1405, only provide substitute tones as described above for the 5^{th}, 10^{th}, 14^{th}, 24^{th}, 28^{th}, 33^{rd} 26 tone resource units, and the 5^{th} and 12^{th} 52 tone resource units.

An alternative implementation of block 1430 does not puncture any of the tones determined in either blocks 1420 and/or 1425. Thus, in these aspects, encoded data (such as quadrature amplitude modulation symbols) is transmitted using the impacted tones. In these aspects, the encoded data transmitted using impacted tones may also be transmitted using additional tones, including the additional tones as described above. In these aspects, data transmitted using impacted tones may be transmitted in two forms, using two different tones. However, because one of the copies is transmitted via an impacted tone that copy may not be properly received by the second wireless device.

In some of these alternative aspects selecting the HE-80 tone plan in block 1405, data is encoded using two tones as described above except for the 2^{nd}, and 7^{th} 106 tone resource units and the 1^{st} and 4^{th} 242 tone resource units. In some other sub-aspects of these alternative aspects, dual tones are used to transmit encoded data (such as quadrature amplitude modulation symbols) only for the 5^{th} 10^{th} 14^{th} 24th 28th, 33^{rd} 26 tone resource units and the 5^{th} and 12^{th} 52-tone resource units.

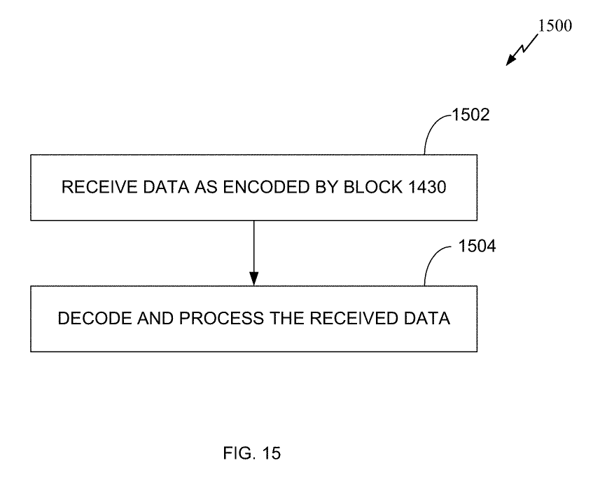

FIG. 15 is a flowchart for a method of decoding data encoded by process 1400, discussed above. In some aspects, the process 1500 may be performed by the wireless device 202. For example, in some aspects, memory 206 may store instructions that configure the processor 204 to perform one or more of the functions discussed below with respect to FIG. 14.

While FIG. 14 shows functions that may be performed by a device communicating data according to the tone plans described above, some aspects including devices receiving and decoding the data. For example, to the extent particular tones or resource units are unused relative to an 802.11ax tone plan, a receiving device will selectively ignore those tones and/or resource units. Similarly, to the extent data is transmitted using dual tones as described above, a receiving device will decode a received message according to the use of the dual tones. For example, a receiving device may first decode one of the dual tones for data (for example, the supplemental tone outside the standard 802.11ax tone plan, and if unsuccessful, may then attempt to decode the other of the dual tones, for example, the tone called for by the standard 802.11ax tone plan in use. Similarly, to the extent the transmission embodiment described above describes relocation of data from impacted tones to other tones, a device receiving the encoded data would decode data from the new locations.

In block 1505, a frame encoded and transmitted by block 1430 of FIG. 14 may be received. Thus, the frame received in block 1505 may have any of the characteristics or attributes described above with respect to FIG. 14.

In block 1504, the received frame is decoded according to the encoding described above with respect to FIG. 14 and the decoded data is processed. In some aspects, processing the frame may include passing data encoded in the frame to an application program, such as a cell phone application, video streaming application, text messaging application, or other applications known in the art.

FIG. 15 is a flowchart for a method of decoding data encoded by the method of FIG. 14.

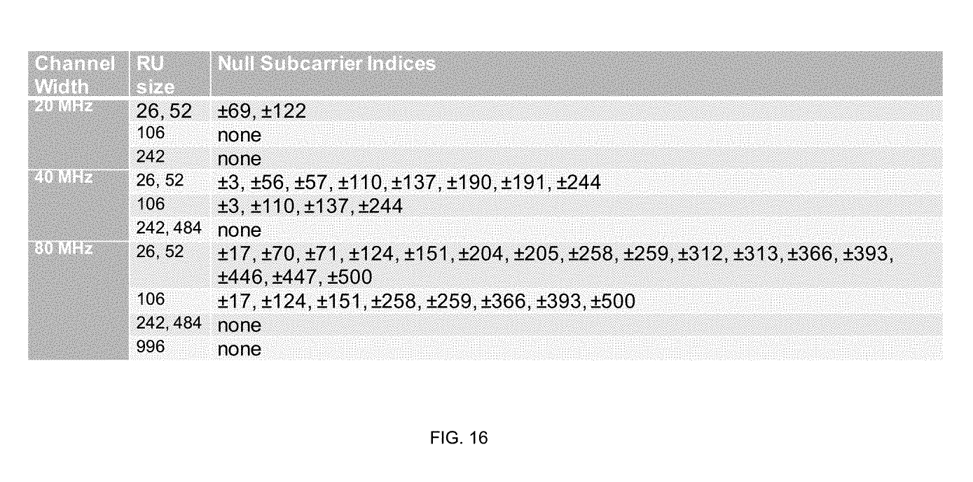

FIG. 16 is a table of null subcarrier indices for high efficiency 20 MHz, 40 MHz, and 80 MHz tone plans in 802.11ax.

FIG. 17 is a table of subcarrier indices for resource units (RUs) in a 20 MHz high efficiency PPDU.

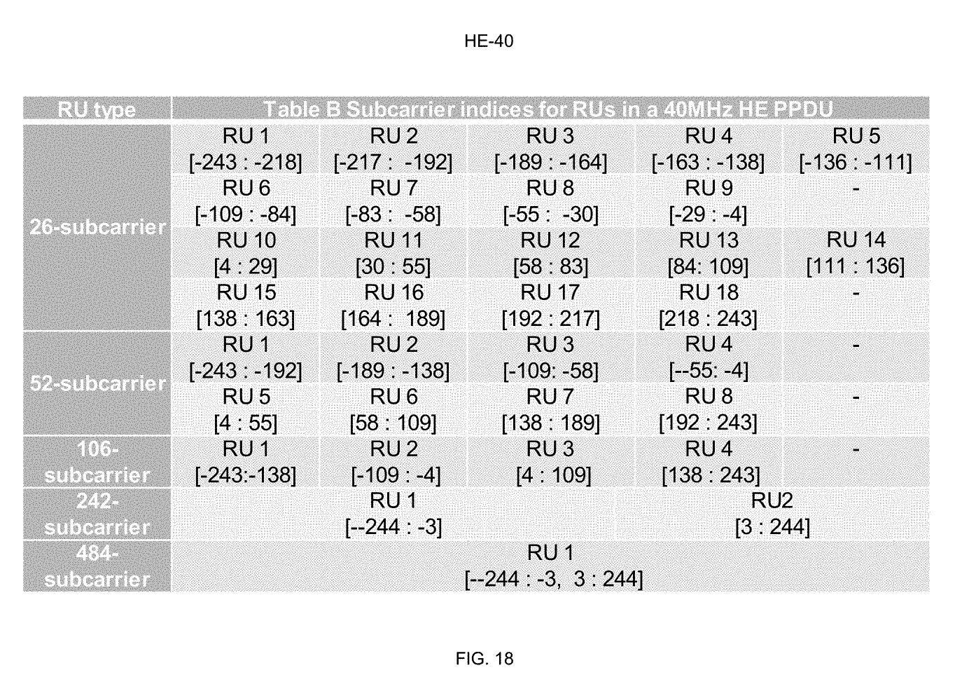

FIG. 18 is a table of subcarrier indices for resource units in a 40 MHz high efficiency PPDU.

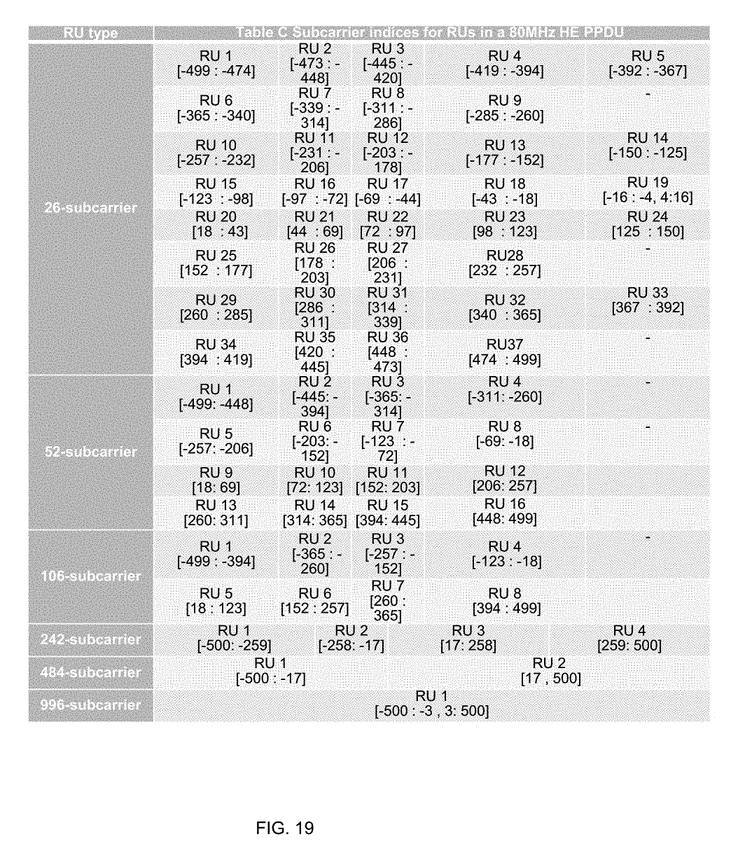

FIG. 19 is a table of subcarrier indices for resource units in a 80 MHz high efficiency PPDU.

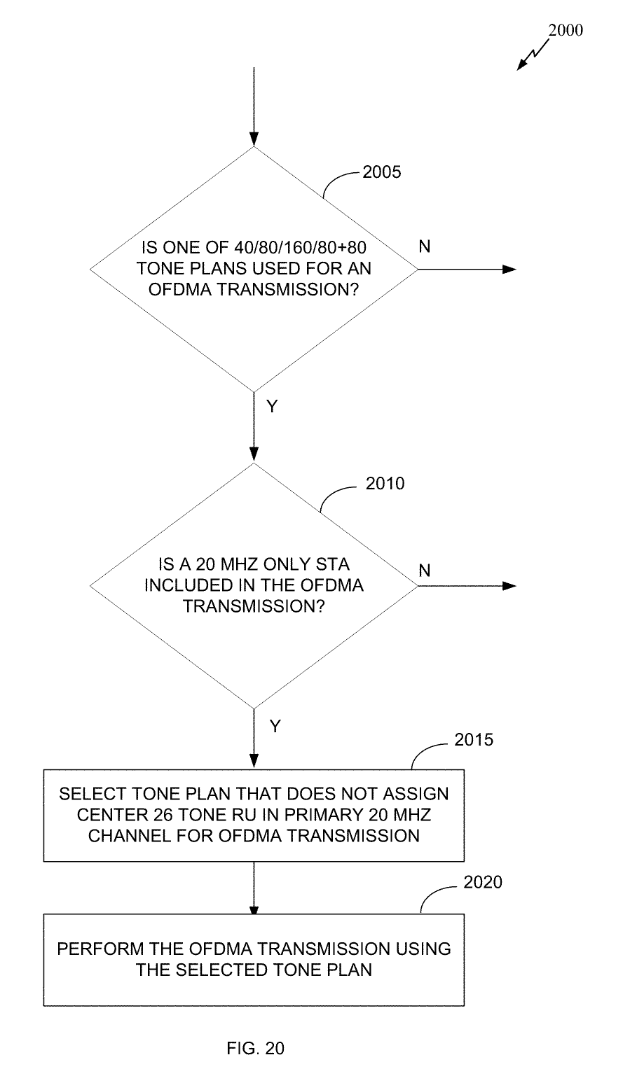

FIG. 20 is a flowchart of a method selecting a tone plan. In some aspects, a tone plan is selected that avoids assigning data to particular tones when performing an OFDMA communication that includes a reduced bandwidth device, such as a device capable of operating with only a 20 Mhz bandwidth. In some aspects, process 2000 discussed with respect to FIG. 20 may be performed by the wireless device 202. In some aspects, the wireless device 202 may be an access point, such as the AP 104 discussed above. Decision block 2005 determines whether a tone plan used for an OFDMA transmission is one of an HE 40, HE 80, HE 160, or HE 80-plus-80 tone plan. If a different tone plan of used, process 2000 continues to the right. Otherwise, if one of the identified tone plans is used for the transmission, then decision block 2010 determines whether a 20 Mhz only station is included in the OFDMA transmission. If such a device is included in the transmission, process 2000 moves to block 2015.

Block 2015 selects a tone plan that does not assign a center 26 tone resource unit in a primary 20 Mhz channel for the OFDMA transmission.

In block 2020, the OFDMA transmission is performed using the selected tone plan.

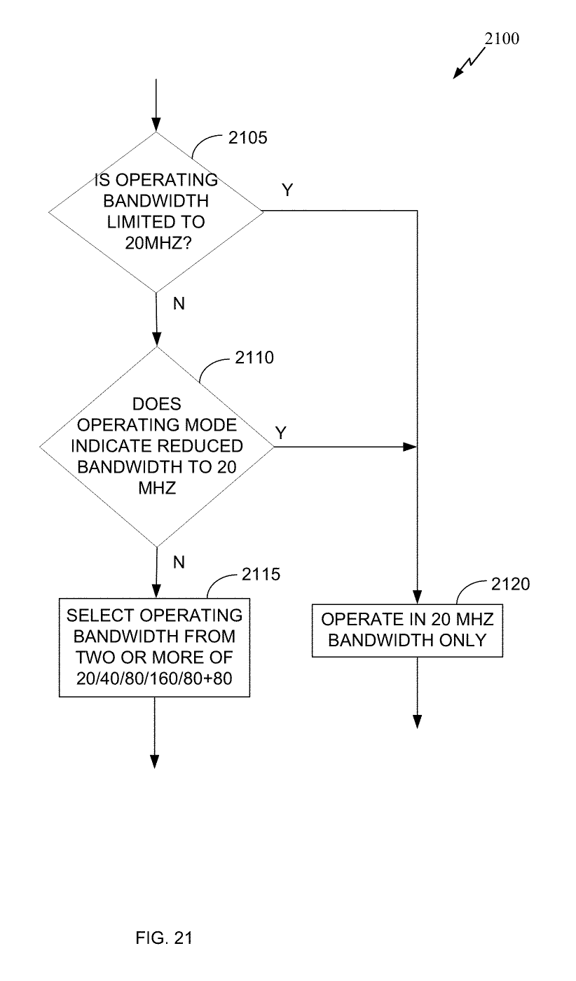

FIG. 21 is a flowchart of a method of selecting an operating bandwidth. In some aspects, the process 2100 discussed below with respect to FIG. 21 may be performed by the wireless device 202. For example, the hardware processor 204 may be configured by instructions stored in the memory 206 to perform one or more of the functions discussed below with respect to FIG. 21.

Decision block 2105 determines whether an operating bandwidth of a station is limited to 20 Mhz. For example, in some aspects, a station may have receiver/transmitter/transceiver hardware that is only capable of transmissions/receptions within a 20 Mhz frequency band.

If the operating bandwidth is limited, process 2100 moves to block 2120, where the device operates in a 20 Mhz bandwidth only. Operating in a 20 Mhz bandwidth may include participating in an OFDMA communication, wherein data either received or transmitted in the OFDMA communication is encoded within a 20 Mhz bandwidth.

If the operating bandwidth of the device performing process 2100 is not limited to 20 Mhz, process 21000 moves to decision block 2110, which determines whether an operating mode indicates that the device should reduce its bandwidth to 20 Mhz. If the mode indicates the bandwidth is reduced, process 2100 moves from decision block 2110 to block 2120, which operates as discussed above.

Otherwise, process 2100 moves to block 2115 from decision block 2110. In block 2115, the device performing process 2100 selects a bandwidth to operate in from two or more of a 20 Mhz, 40 Mhz, 80 Mhz, 160 Mhz, or an 80-plus-80 Mhz bandwidth.

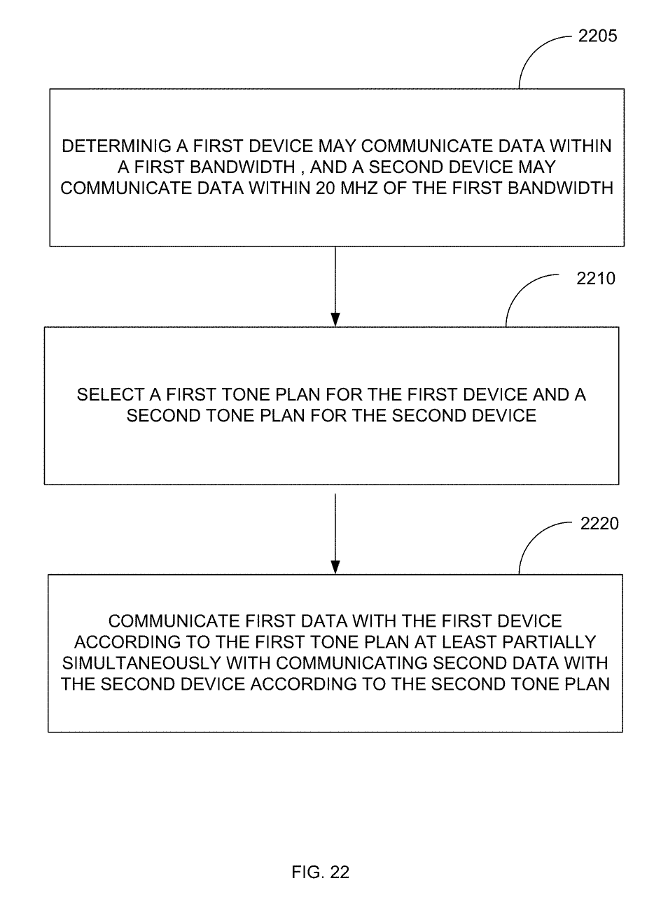

FIG. 22 is a flowchart of a method for communicating with a first and second device. The second device may be a reduced bandwidth device, in that the second device may only be able to communicate with a 20 Mhz bandwidth. The first device may be able to communicate within a wider bandwidth, such as a 40 Mhz, 80 Mhz, 160 Mhz, or 80+80 Mhz bandwidth. In some aspects, the process 2200 discussed below with respect to FIG. 22 may be performed by the wireless device 202. For example, instructions stored in the memory 206 may configure the hardware processor 204 to perform one or more of the functions discussed below. By selecting particular tone plans for each of the first and second devices, process 2200 may allow an access point to simultaneously communicate with the first device over a wide bandwidth while also communicating with the second device over the reduced 20 Mhz bandwidth. In some aspects, the second device may be a legacy device, and thus may have less capable hardware. In the discussion that follows, a device performing process 2200 may be referred to as the process 2200 device. In some aspects, process 2200 may be performed by an access point.

Block 2205 determines that the first device communicates data within a first bandwidth, while a second device communicates data within 20 Mhz second bandwidth. The second bandwidth may fall within the first bandwidth. In some aspects, the first bandwidth may be 40 Mhz, 80 Mhz, 160 Mhz, or 80-plus-80 Mhz. In some aspects, the second device communicates data within a 20 Mhz primary channel of the first device. In some aspects, process 2200 may determine that multiple devices are to communicate within the first bandwidth and/or the second bandwidth. For example, a third device communicates within the first bandwidth simultaneously with the first and second device. A fourth device communicates within the second bandwidth simultaneously with the first, second and/or third devices in some aspects.

In block 2210, a first tone plan is selected for the first device and a second tone plan is selected for the second device. The first tone plan may utilize a first set of resource units with the second bandwidth to communicate data. The second tone plan may utilize a subset of the first set of resource units to communicate data within the second bandwidth. In some aspects, both the first and second tone plans may restrict a center 26 tone resource unit of the first and second bandwidths. In some aspects where the process 2200 device and the first device communicate over a 40 Mhz bandwidth, the second tone plan restricts a 5^{th} and 14^{th} 26 tone resource unit.

In some aspects where the process 2200 device and the first device communicate over an 80 Mhz bandwidth, the second tone plan restricts the 5^{th}, 10^{th}, 14^{th}, 19^{th}, 24^{th}, 28^{th}, and 33^{rd} 26 tone resource units. In some other aspects where the process 2200 device and the first device communicate over an 80 Mhz bandwidth, the second tone plan restricts the 5th and 12th 52 tone resource units. In some other aspects where the process 2200 device and the first device communicate over an 80 Mhz bandwidth, the second tone plan restricts the 3^{rd} and 6^{th} 106 tone resource units.

In some aspects where uplink data is transmitted from the second device to the process 2200 device, the second tone plan restricts the 242 tone resource unit. In some aspects where downlink data is transmitted from the process 2200 device to the second device, the second tone plan restricts the 242 tone resource unit. However, in other aspects, downlink transmissions do not restrict the 242 tone resource unit.

In some aspects where the process 2200 device and the first device communicate using a 160 Mhz bandwidth or an 80+80 Mhz bandwidth, the first tone plan includes a first portion allocated to 80 Mhz of the bandwidth, and a second portion allocated to a second non-overlapping 80 Mhz of the bandwidth, and wherein the second portion duplicates the first portion.

In block 2220, first data is communicated with the first device over the wider bandwidth simultaneously with second data being communicated with the second device over the narrower 20 Mhz bandwidth. Communication with the first device utilizes the first tone plan while communication with the second device uses the second tone plan. In some aspects, the communication of the first data and second data is performed as part of an orthogonal frequency division multiple access (OFDMA) transmission.

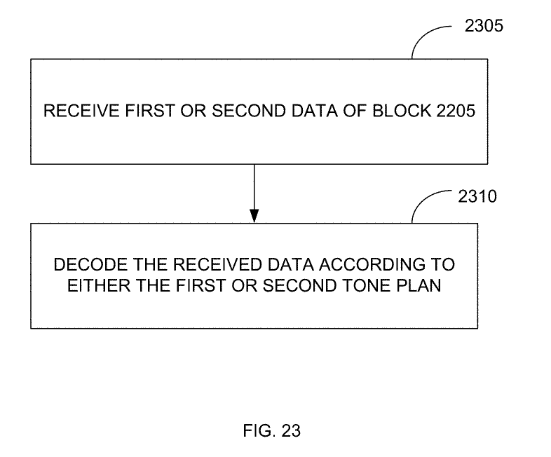

FIG. 23 is a flowchart of a method for receiving a portion of a multi-user transmission. The multi-user transmission may include first data for a first device and second data for a second device. The first data may be transmitted over a different bandwidth than the second data. For example, the second data may be transmitted over a 20 Mhz bandwidth, while the first data may be transmitted over a wider bandwidth, but a bandwidth that includes the 20 Mhz bandwidth used to transmit second data.

In some aspects, the second device may be a legacy device, and thus may have less capable hardware. In the discussion that follows, a device performing process 2300 may be referred to as the process 2300 device. In some aspects, process 2300 may be performed by a station.

In block 2305, a multi-user transmission is received. The multi-user transmission includes first data destined for a first device and second data destined for a second device. As discussed above, the first data may be transmitted over a wider bandwidth than the second data. First data may be encoded according to a first tone plan and second data may be encoded according to a second tone plan.

In block 2310, the multi-user transmission is decoded according to the first or the second tone plan. When process 2300 is performed by the first device, the transmission is decoded according to the first tone plan, while when process 2300 is performed by the second device, the transmission is decoded according to the second tone plan. In some aspects, the multi-user communication is decoded while excluding a center 26 tone resource unit according to the first or second tone plan. In some aspects, the multi-user communication is decoded while excluding a 5^{th} and a 14^{th} 26 tone resource unit according to the second tone plan. In some aspects, the multi-user communication is decoded while excluding the 5^{th}, 10^{th}, 14^{th}, 19^{th}, 24^{th}, 28^{th}, and 33^{rd} 26 tone resource units according to the second tone plan. In some aspects, the multi-user communication is decoded while excluding the 5th and 12th 52 tone resource units according to the second tone plan. In some aspects, the multi-user communication is decoded while excluding the 3^{rd} and 6^{th} 106 tone resource units according to the second tone plan. In some aspects, the multi-user communication is decoded while excluding the 242 tone resource unit according to the second tone plan. In some aspects, the multi-user communication is decoded by decoding the 242 tone resource unit according to the second tone plan. Some aspects of process 2300 include receiving the data from the first device over a 160 Mhz or a 80 Mhz+80 Mhz bandwidth, wherein the first tone plan includes a first portion allocated to 80 Mhz of the bandwidth, and a second portion allocated to a second non-overlapping 80 Mhz of the bandwidth, and wherein the second portion duplicates the first portion.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. An apparatus for communicating with multiple devices, comprising:
an electronic hardware processor, configured to:
determine a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width,
select a first tone plan for communication by the first device based on the determination, wherein the first tone plan includes tones in one or more resource units in the first channel width;
select a second tone plan for communication by the second device based on the determination, wherein the second tone plan includes tones in one or more resource units in the second channel width; and
communicate first data with the first device according to the first tone plan at least partially simultaneously with communicating second data with the second device according to the second tone plan.

2. The apparatus of claim 1, wherein the first and second tone plans restrict use of a center 26 tone resource unit within a 20 Mhz bandwidth overlapping the first and second channel widths for communication.

3. The apparatus of claim 1, wherein the electronic hardware processor is configured to select 40 Mhz for the first channel width, and the second tone plan restricts use of a 5^{th} and a 14^{th} 26 tone resource unit of the second channel width of 20 Mhz second bandwidth for communication.

4. The apparatus of claim 1, wherein the electronic hardware processor is configured to select 80 Mhz for the first channel width, and the second tone plan restricts use of a 5^{th}, a 10^{th}, a 14^{th}, a 19^{th}, a 24^{th}, a 28^{th}, and a 33^{rd} 26 tone resource unit within the second channel width for communication.

5. The apparatus of claim 1, wherein the hardware processor is configured to select either 160 Mhz or 80-plus-80 Mhz for the first channel width, and the second tone plan restricts use of a 5^{th}, a 10^{th}, a 14^{th}, a 19^{th}, a 24^{th}, a 28^{th}, and a 33^{rd} 26 tone resource unit within the second channel width for communication.

6. The apparatus of claim 1, wherein the electronic hardware processor is configured to select 80 Mhz for the first channel width, and the second tone plan restricts use of a 5th and a 12th 52 tone resource unit within the second channel width for communication.

7. The apparatus of claim 1, wherein the electronic hardware processor is configured to select 160 Mhz or 80-plus-80 Mhz for the first channel width, and the second tone plan restricts use of a 5^{th} and a 12^{th} 52 tone resource unit within the second channel width for communication.

8. The apparatus of claim 1, wherein the electronic hardware processor is configured to select 80 Mhz for the first channel width, and the second tone plan restricts use of a 3^{rd} and a 6^{th} 106 tone resource unit within the second channel width for communication.

9. The apparatus of claim 1, wherein the electronic hardware processor is configured to select 160 Mhz or 80-plus-80 Mhz for the first channel width, and the second tone plan restricts use of a 3^{rd} and a 6^{th} 106 tone resource unit in the second channel width for communication.

10. The apparatus of claim 1, wherein the electronic hardware processor is further configured to:
determine a third device communicates data within the first channel width and a fourth device communicates data within the second width,
select the first tone plan for the third device and the second tone plan for the fourth device based on the determination; and
communicate third data with the third device according to the first tone plan at least partially simultaneously with communicating fourth data with the fourth device according to the second tone plan.

11. The apparatus of claim 10, wherein the electronic hardware processor is further configured to communicate the third and fourth data at least partially simultaneously with the communication of the first and second data.

12. The apparatus of claim 1, wherein the electronic hardware processor is configured to determine that the first device transmits data within the first channel width, and the second tone plan restricts use of a 242 tone resource unit within the second channel width for communication.

13. The apparatus of claim 1, wherein the electronic hardware processor is configured to determine that the first device receives data within the first channel width, and the second tone plan restricts use of a 242 tone resource unit within the second channel width for communication.

14. The apparatus of claim 1, wherein the electronic hardware processor is configured to determine that the first device receives data within the first bandwidth, and the second tone plan does not restrict use of a 242 tone resource unit within the second channel width for communication.

15. A method of communicating data with multiple devices, comprising:
determining a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width;
selecting a first tone plan for communication by the first device based on the determination, wherein the first tone plan includes tones in one or more resource units in the first channel width;
selecting a second tone plan for communication by the second device based on the determination, wherein the second tone plan includes tones in one or more resource units in the second channel width; and
communicating first data with the first device according to the first tone plan at least partially simultaneously with communicating second data with the second device according to the second tone plan.

16. The method of claim 15, wherein the first and second tone plans restrict use of a center 26 tone resource unit within a 20 Mhz bandwidth overlapping the first and second channel widths for communication.

17. The method of claim 15, further comprising selecting 40 Mhz for the first channel width, and selecting a second tone plan that restricts use of a 5^{th} and a 14^{th} 26 tone resource unit of the second channel width of 20 Mhz second bandwidth for communication.

18. The method of claim 15, further comprising selecting 80 Mhz for the first channel width, and selecting a second tone plan that restricts use of a 5^{th}, a 10^{th}, a 14^{th}, a 19^{th}, a 24^{th}, a 28^{th}, and a 33^{rd} 26 tone resource unit within the second channel width for communication.

19. The method of claim 15, further comprising selecting 160 Mhz or 80-plus-80 Mhz for the first channel width, and selecting a second tone plan that restricts use of a 5^{th}, a 10^{th}, a 14^{th}, a 19^{th}, a 24^{th}, a 28^{th}, and a 33^{rd} 26 tone resource unit within the second channel width for communication.

20. The method of claim 15, further comprising selecting 80 Mhz for the first channel width, and selecting a second tone plan that restricts use of a 5th and a 12th 52 tone resource unit within the second channel width for communication.

21. The method of claim 15, further comprising selecting 160 Mhz or 80-plus-80 Mhz for the first channel width, and selecting a second tone plan that restricts use of a 5^{th} and a 12^{th} 52 tone resource unit within the second channel width for communication.

22. The method of claim 15, further comprising selecting 80 Mhz for the first channel width, and selecting a second tone plan that restricts use of a 3^{rd} and a 6^{th} 106 tone resource unit within the second channel width for communication.

23. The method of claim 15, further comprising selecting 160 Mhz or 80-plus-80 Mhz for the first channel width, and selecting a second tone plan that restricts use of a 3^{rd} and a 6^{th} 106 tone resource unit in the 20 Mhz second channel width for communication.

24. The method of claim 15, further comprising:
determining a third device communicates data within the first channel width and a fourth device communicates data within the second width,
selecting the first tone plan for the third device and the second tone plan for the fourth device based on the determination; and
communicating third data with the third device according to the first tone plan at least partially simultaneously with communicating fourth data with the fourth device according to the second tone plan.

25. The method of claim 24, further comprising communicating the third and fourth data at least partially simultaneously with the communication of the first and second data.

26. The method of claim 15, wherein the electronic hardware processor is configured to determine that the first device transmits data within the first channel width, and the second tone plan restricts use of a 242 tone resource unit within the second channel width for communication.

27. The method of claim 15, wherein the electronic hardware processor is configured to determine that the first device receives data within the first channel width, and the second tone plan restricts use of a 242 tone resource unit within the second channel width for communication.

28. The method of claim 15, wherein the electronic hardware processor is configured to determine that the first device receives data within the first bandwidth, and the second tone plan does not restrict use of a 242 tone resource unit within the second channel width for communication.

29. An apparatus for communicating data with multiple devices, comprising:
means for determining a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width;
means for selecting a first tone plan for communication by the first device based on the determination, wherein the first tone plan includes tones in one or more resource units in the first channel width;
means for selecting a second tone plan for communication by the second device based on the determination, wherein the second tone plan includes tones in one or more resource units in the second channel width; and
means for communicating first data with the first device according to the first tone plan at least partially simultaneously with communicating second data with the second device according to the second tone plan.

30. A computer readable storage medium comprising instructions that when executed cause a hardware processor to perform a method of communicating data with multiple devices, the method comprising:
determining a first device is able to communicate in a first channel width selected from 40 Mhz, 80 Mhz, 160 Mhz or 80 Mhz-plus-80 Mhz bandwidths and a second device is able to communicate in a second channel width of 20 Mhz bandwidth, wherein an operating spectrum of the first and second channel widths are overlapping and the second channel width is within the first channel width;
selecting a first tone plan for communication by the first device based on the determination, wherein the first tone plan includes tones in one or more resource units in the first channel width;
selecting a second tone plan for communication by the second device based on the determination, wherein the second tone plan includes tones in one or more resource units in the second channel width; and
communicating first data with the first device according to the first tone plan at least partially simultaneously with communicating second data with the second device according to the second tone plan.
